(19) United States
(12) Patent Application Publication
(10) Pub. No.: US 2023/0319766 A1
(43) Pub. Date: Oct. 5, 2023

(54) GROUP COMMON DOWNLINK CONTROL INFORMATION (DCI) FOR APERIODIC POSITIONING REFERENCE SIGNAL (PRS) TRIGGERING

(71) Applicant: QUALCOMM Incorporated, San Diego, CA (US)

(72) Inventors: Alexandros MANOLAKOS, Escondido, CA (US); Sony AKKARAKARAN, Poway, CA (US); Srinivas YERRAMALLI, San Diego, CA (US); Peter GAAL, San Diego, CA (US)

(21) Appl. No.: 18/041,336

(22) PCT Filed: Sep. 22, 2021
(86) PCT No.: PCT/US2021/051429

§ 371 Date: Feb. 10, 2023

(30) Foreign Application Priority Data
Oct. 15, 2020 (IN) 202021044991

(51) Int. Cl. H04W 64/00; G01S 5/00; G01S 5/02; H04L 5/00

(52) U.S. Cl. CPC H04W 64/00; G01S 5/0036; G01S 5/0226; H04L 5/0051

(57) ABSTRACT

Group common Downlink Control Information (DCI) for Aperiodic Positioning Reference Signal (AP-PRS) triggering is described herein. Embodiments for such AP-PRS may include AP-PRS triggering commands and/or positioning measurement request commands, and may be mapped to one or more bits of different blocks of the group common DCI to identify different aspects of the AP-PRS, such as one or more Positioning Frequency Layers (PFLs), PRS identifiers (PRS-IDs), PRS resource sets, and/or PRS resources.

### RELATED APPLICATIONS

This application claims the benefit of Indian Pat. Application No. 202021044991, filed Oct. 15, 2020, entitled “Group Common Downlink Control Information (DCI) for Aperiodic Positioning Reference Signal (PRS) Triggering,” which is assigned to the assignee hereof and incorporated by reference herein in its entirety.

### BACKGROUND

### 1. Field of Invention

The present invention relates generally to the field of wireless communications, and more specifically to determining the location of a User Equipment (UE) using radio frequency (RF) signals.

### 2. Description of Related Art

In a Fifth Generation (5G) New Radio (NR) mobile communication network, base stations may transmit Positioning Reference Signals (PRS) that can be measured at a UE to determine the location of the UE using any of a variety of network-based positioning methods. For periodic PRS, the UE may know when base stations transmit the PRS based on a known periodicity for the PRS. On the other hand, for aperiodic PRS (AP-PRS), the network may need to provide information regarding the transmittal of PRS by one or more base stations to the UE, “triggering” the base stations to monitor the PRS and/or report measurement information. The way in which this triggering information may be provided to multiple UEs has not yet been defined.

### BRIEF SUMMARY

Group common Downlink Control Information (DCI) for Aperiodic Positioning Reference Signal (AP-PRS) triggering is described herein. Embodiments for such AP-PRS may include AP-PRS triggering commands and/or positioning measurement request commands, and may be mapped to one or more bits of different blocks of the group common DCI to identify different aspects of the AP-PRS, such as one or more Positioning Frequency Layers (PFLs), PRS identifiers (PRS-IDs), PRS resource sets, and/or PRS resources.

An example method of providing aperiodic Position Reference Signal (AP-PRS) information to at least one User Equipment (UE) via group common Downlink Control Information (DCI) for the at least one UE, according to this disclosure, may comprise determining information regarding transmission of an AP-PRS by a Transmission and Reception Point (TRP). The method also may comprise sending, in the group common DCI for the at least one UE, one or more information blocks, wherein each information block of the one or more information blocks comprises one or more bits that map to: a trigger command related to the AP-PRS, a positioning measurement request command related to the AP-PRS, or a location report request command related to the AP-PRS, or a combination thereof. The method also may comprise transmitting the group common DCI.

An example method at a User Equipment (UE) of using aperiodic Position Reference Signal (AP-PRS) information in group common Downlink Control Information (DCI), according to this disclosure, may comprise receiving from a serving Transmission Reception Point (TRP), in the group common DCI, a one or more information blocks, wherein each information block of the one or more information blocks comprises one or more bits that map to a trigger command related to an AP-PRS, wherein the AP-PRS is transmitted from the serving TRP or a neighboring TRP, a positioning measurement request command related to the AP-PRS, a location report request command related to the AP-PRS, or a combination thereof. The method also may comprise measuring the AP-PRS based on the trigger command, the positioning measurement request command, the location report request command, or the combination thereof, corresponding to the one or more information blocks of the group common DCI.

An example serving Transmission and Reception Point (TRP) for providing aperiodic Position Reference Signal (AP-PRS) information to at least one User Equipment (UE) via group common Downlink Control Information (DCI) for the at least one UE, according to this disclosure, may comprise a transceiver, a memory, one or more processors communicatively coupled with the transceiver and the memory, wherein the one or more processors are configured to determine information regarding transmission of an AP-PRS by the serving TRP or a separate TRP. The one or more processors further may be configured to send, in the group common DCI for the at least one UE, one or more information blocks, wherein each information block of the one or more information blocks comprises one or more bits that map to: a trigger command related to the AP-PRS, a positioning measurement request command related to the AP-PRS, or a location report request command related to the AP-PRS, or a combination thereof. The one or more processors further may be configured to transmit the group common DCI via the transceiver.

An example user equipment (UE) for using aperiodic Position Reference Signal (AP-PRS) information in group common Downlink Control Information (DCI), according to this disclosure, may comprise a transceiver, a memory, one or more processors communicatively coupled with the transceiver and the memory, wherein the one or more processors are configured to receive from a serving Transmission Reception Point (TRP) via the transceiver, in the group common DCI, a one or more information blocks, wherein each information block of the one or more information blocks comprises one or more bits that map to a trigger command related to an AP-PRS, wherein the AP-PRS is transmitted from the serving TRP or a neighboring TRP, a positioning measurement request command related to the AP-PRS, a location report request command related to the AP-PRS, or a combination thereof. The one or more processors further may be configured to measure the AP-PRS based on the trigger command, the positioning measurement request command, or the location report request command, or the combination thereof, corresponding to the one or more information blocks of the group common DCI.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

FIG. 1 is a simplified illustration of a positioning system, according to an embodiment.

FIG. 2 is a diagram of a 5th Generation (5G) New Radio (NR) positioning system, illustrating an embodiment of a positioning system (e.g., the positioning system of FIG. 1) implemented within a 5G NR communication system.

FIG. 3 is a diagram showing an example of a frame structure for NR and associated terminology.

FIG. 4 is a diagram showing an example of a radio frame sequence with Positioning Reference Signal (PRS) positioning occasions.

FIG. 5 is a diagram of a hierarchical structure of how PRS resources and PRS resource sets may be used by different Transmission Reception Points (TRPs) of a given frequency layer (FL), as defined in 5G NR, according to some embodiments.

FIG. 6 is an illustration how Observed Time Difference Of Arrival (OTDOA)-based positioning can be made, according to some embodiments.

FIG. 7 is an illustration how Round Trip signal propagation Time (RTT)-based positioning (or multi-RTT) can be made, according to some embodiments.

FIG. 8 is an illustration how angle of departure (AOD)-based positioning can be made, according to some embodiments.

FIG. 9 is a diagram that illustrates the structure of a group common Downlink Control Information (DCI), according to an embodiment.

FIG. 10 is a diagram illustrating how, according to some embodiments, blocks of a group common DCI may include aperiodic PRS (AP-PRS) trigger commands and positioning measurement report commands.

FIG. 11 is a flow diagram of a method of providing AP-PRS information to at least one UE via group common DCI, according to an embodiment

FIG. 12 is a block diagram of an embodiment of a UE, which can be utilized in embodiments as described herein.

FIG. 13 is a block diagram of an embodiment of a TRP, which can be utilized in embodiments as described herein.

FIG. 14 is a block diagram of an embodiment of a computer system, which can be utilized in embodiments as described herein.

FIG. 15 is a flow diagram of a method of using AP-PRS information in group common DCI, according to an embodiment.

Like reference symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3 etc. or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c).

### DETAILED DESCRIPTION

The following description is directed to certain implementations for the purposes of describing innovative aspects of various embodiments. However, a person having ordinary skill in the art will readily recognize that the teachings herein can be applied in a multitude of different ways. The described implementations may be implemented in any device, system, or network that is capable of transmitting and receiving radio frequency (RF) signals according to any communication standard, such as any of the Institute of Electrical and Electronics Engineers (IEEE) IEEE 802.11 standards (including those identified as Wi-Fi® technologies), the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Rate Packet Data (HRPD), High Speed Packet Access (HSPA), High Speed Downlink Packet Access (HSDPA), High Speed Uplink Packet Access (HSUPA), Evolved High Speed Packet Access (HSPA+), Long Term Evolution (LTE), Advanced Mobile Phone System (AMPS), or other known signals that are used to communicate within a wireless, cellular or internet of things (IoT) network, such as a system utilizing 3G, 4G, 5G, 6G, or further implementations thereof, technology.

As used herein, an “RF signal” comprises an electromagnetic wave that transports information through the space between a transmitter (or transmitting device) and a receiver (or receiving device). As used herein, a transmitter may transmit a single “RF signal” or multiple “RF signals” to a receiver. However, the receiver may receive multiple “RF signals” corresponding to each transmitted RF signal due to the propagation characteristics of RF signals through multiple channels or paths.

Additionally, unless otherwise specified, references to “reference signals,” “positioning reference signals,” “reference signals for positioning,” and the like may be used to refer to signals used for positioning of a user equipment (UE). As described in more detail herein, such signals may comprise any of a variety of signal types but may not necessarily be limited to a Positioning Reference Signal (PRS) as defined in relevant wireless standards.

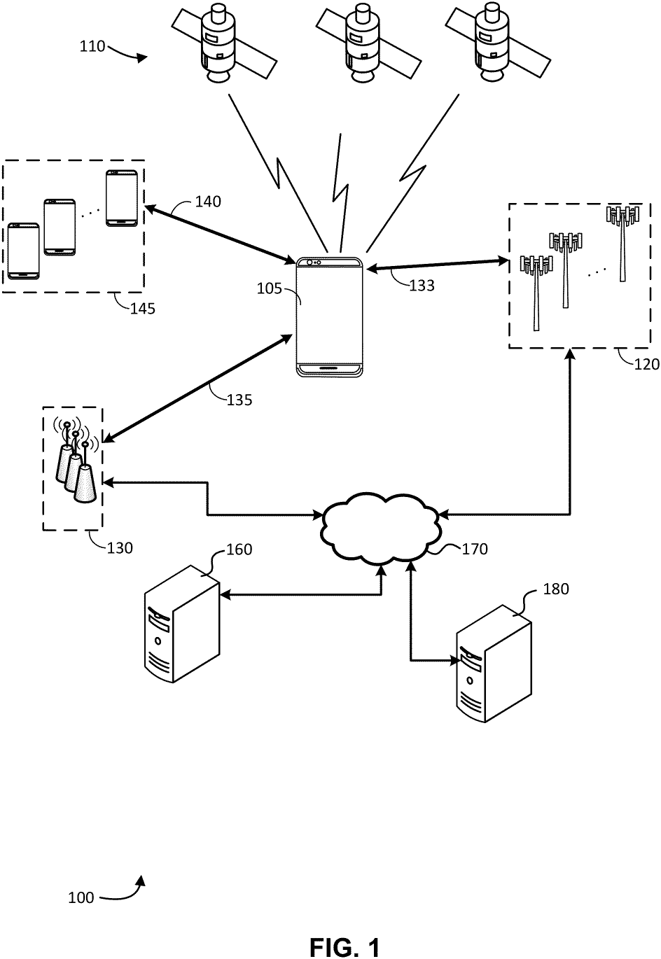

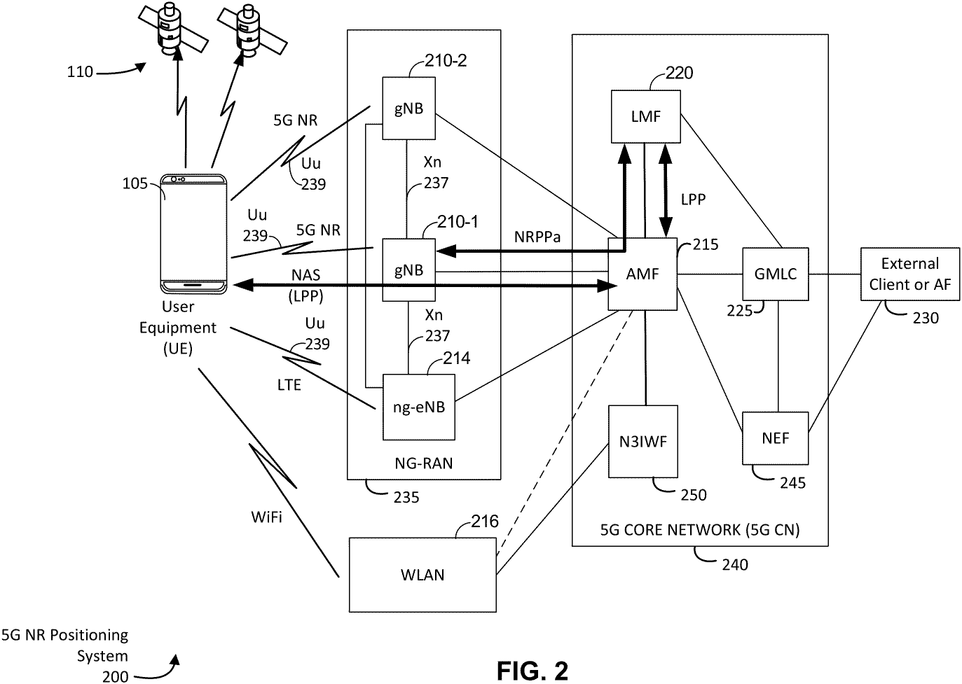

FIG. 1 is a simplified illustration of a positioning system 100 in which a UE 105, location server 160, and/or other components of the positioning system 100 can use the techniques provided herein for determining and estimated location of UE 105, according to an embodiment. The techniques described herein may be implemented by one or more components of the positioning system 100. The positioning system 100 can include: a UE 105; one or more satellites 110 (also referred to as space vehicles (SVs)) for a Global Navigation Satellite System (GNSS) such as the Global Positioning System (GPS), GLONASS, Galileo or Beidou; base stations 120; access points (APs) 130; location server 160; network 170; and external client 180. Generally put, the positioning system 100 can estimate a location of the UE 105 based on RF signals received by and/or sent from the UE 105 and known locations of other components (e.g., GNSS satellites 110, base stations 120, APs 130) transmitting and/or receiving the RF signals. Additional details regarding particular location estimation techniques are discussed in more detail with regard to FIG. 2.

It should be noted that FIG. 1 provides only a generalized illustration of various components, any or all of which may be utilized as appropriate, and each of which may be duplicated as necessary. Specifically, although only one UE 105 is illustrated, it will be understood that many UEs (e.g., hundreds, thousands, millions, etc.) may utilize the positioning system 100. Similarly, the positioning system 100 may include a larger or smaller number of base stations 120 and/or APs 130 than illustrated in FIG. 1. The illustrated connections that connect the various components in the positioning system 100 comprise data and signaling connections which may include additional (intermediary) components, direct or indirect physical and/or wireless connections, and/or additional networks. Furthermore, components may be rearranged, combined, separated, substituted, and/or omitted, depending on desired functionality. In some embodiments, for example, the external client 180 may be directly connected to location server 160. A person of ordinary skill in the art will recognize many modifications to the components illustrated.

Depending on desired functionality, the network 170 may comprise any of a variety of wireless and/or wireline networks. The network 170 can, for example, comprise a combination of public and/or private networks, local and/or wide-area networks, and the like. Furthermore, the network 170 may utilize one or more wired and/or wireless communication technologies. In some embodiments, the network 170 may comprise a cellular or other mobile network, a wireless local area network (WLAN), a wireless wide-area network (WWAN), and/or the Internet, for example. Examples of network 170 include a Long-Term Evolution (LTE) wireless network, a Fifth Generation (5G) wireless network (also referred to as New Radio (NR) wireless network or 5G NR wireless network), a Wi-Fi WLAN, and the Internet. LTE, 5G and NR are wireless technologies defined, or being defined, by the 3rd Generation Partnership Project (3GPP). Network 170 may also include more than one network and/or more than one type of network.

The base stations 120 and access points (APs) 130 may be communicatively coupled to the network 170. In some embodiments, the base station 120s may be owned, maintained, and/or operated by a cellular network provider, and may employ any of a variety of wireless technologies, as described herein below. Depending on the technology of the network 170, a base station 120 may comprise a node B, an Evolved Node B (eNodeB or eNB), a base transceiver station (BTS), a radio base station (RBS), an NR NodeB (gNB), a Next Generation eNB (ng-eNB), or the like. A base station 120 that is a gNB or ng-eNB may be part of a Next Generation Radio Access Network (NG-RAN) which may connect to a 5G Core Network (5GC) in the case that Network 170 is a 5G network. An AP 130 may comprise a Wi-Fi AP or a Bluetooth® AP or an AP having cellular capabilities (e.g., 4G LTE and/or 5G NR), for example. Thus, UE 105 can send and receive information with network-connected devices, such as location server 160, by accessing the network 170 via a base station 120 using a first communication link 133. Additionally or alternatively, because APs 130 also may be communicatively coupled with the network 170, UE 105 may communicate with network-connected and Internet-connected devices, including location server 160, using a second communication link 135, or via one or more other UEs 145.

As used herein, the term “base station” may generically refer to a single physical transmission point, or multiple co-located physical transmission points, which may be located at a base station 120. A Transmission Reception Point (TRP) (also known as transmit/receive point) corresponds to this type of transmission point, and the term “TRP” may be used interchangeably herein with the terms “gNB,” “ng-eNB,” and “base station.” In some cases, a base station 120 may comprise multiple TRPs - e.g. with each TRP associated with a different antenna or a different antenna array for the base station 120. Physical transmission points may comprise an array of antennas of a base station 120 (e.g., as in a Multiple Input-Multiple Output (MIMO) system and/or where the base station employs beamforming). The term “base station” may additionally refer to multiple non-co-located physical transmission points, the physical transmission points may be a Distributed Antenna System (DAS) (a network of spatially separated antennas connected to a common source via a transport medium) or a Remote Radio Head (RRH) (a remote base station connected to a serving base station). Alternatively, the non-co-located physical transmission points may be the serving base station receiving the measurement report from the UE 105 and a neighbor base station whose reference RF signals the UE 105 is measuring.

As used herein, the term “cell” may generically refer to a logical communication entity used for communication with a base station 120, and may be associated with an identifier for distinguishing neighboring cells (e.g., a Physical Cell Identifier (PCID), a Virtual Cell Identifier (VCID)) operating via the same or a different carrier. In some examples, a carrier may support multiple cells, and different cells may be configured according to different protocol types (e.g., Machine-Type Communication (MTC), Narrowband Internet-of-Things (NB-IoT), Enhanced Mobile Broadband (eMBB), or others) that may provide access for different types of devices. In some cases, the term “cell” may refer to a portion of a geographic coverage area (e.g., a sector) over which the logical entity operates.

The location server 160 may comprise a server and/or other computing device configured to determine an estimated location of UE 105 and/or provide data (e.g., “assistance data”) to UE 105 to facilitate location measurement and/or location determination by UE 105. According to some embodiments, location server 160 may comprise a Home Secure User Plane Location (SUPL) Location Platform (H-SLP), which may support the SUPL user plane (UP) location solution defined by the Open Mobile Alliance (OMA) and may support location services for UE 105 based on subscription information for UE 105 stored in location server 160. In some embodiments, the location server 160 may comprise, a Discovered SLP (D-SLP) or an Emergency SLP (E-SLP). The location server 160 may also comprise an Enhanced Serving Mobile Location Center (E-SMLC) that supports location of UE 105 using a control plane (CP) location solution for LTE radio access by UE 105. The location server 160 may further comprise a Location Management Function (LMF) that supports location of UE 105 using a control plane (CP) location solution for NR or LTE radio access by UE 105.

In a CP location solution, signaling to control and manage the location of UE 105 may be exchanged between elements of network 170 and with UE 105 using existing network interfaces and protocols and as signaling from the perspective of network 170. In a UP location solution, signaling to control and manage the location of UE 105 may be exchanged between location server 160 and UE 105 as data (e.g. data transported using the Internet Protocol (IP) and/or Transmission Control Protocol (TCP)) from the perspective of network 170.

As previously noted (and discussed in more detail below), the estimated location of UE 105 may be based on measurements of RF signals sent from and/or received by the UE 105. In particular, these measurements can provide information regarding the relative distance and/or angle of the UE 105 from one or more components in the positioning system 100 (e.g., GNSS satellites 110, APs 130, base stations 120). The estimated location of the UE 105 can be estimated geometrically (e.g., using multiangulation and/or multilateration), based on the distance and/or angle measurements, along with known position of the one or more components.

Although terrestrial components such as APs 130 and base stations 120 may be fixed, embodiments are not so limited. Mobile components may be used. For example, in some embodiments, a location of the UE 105 may be estimated at least in part based on measurements of RF signals 140 communicated between the UE 105 and one or more other UEs 145, which may be mobile or fixed. When or more other UEs 145 are used in the position determination of a particular UE 105, the UE 105 for which the position is to be determined may be referred to as the “target UE,” and each of the one or more other UEs 145 used may be referred to as an “anchor UE.” For position determination of a target UE, the respective positions of the one or more anchor UEs may be known and/or jointly determined with the target UE. Direct communication between the one or more other UEs 145 and UE 105 may comprise sidelink and/or similar Device-to-Device (D2D) communication technologies. Sidelink, which is defined by 3GPP, is a form of D2D communication under the cellular-based LTE and NR standards.

An estimated location of UE 105 can be used in a variety of applications - e.g. to assist direction finding or navigation for a user of UE 105 or to assist another user (e.g. associated with external client 180) to locate UE 105. A “location” is also referred to herein as a “location estimate”, “estimated location”, “location”, “position”, “position estimate”, “position fix”, “estimated position”, “location fix” or “fix”. The process of determining a location may be referred to as “positioning,” “position determination,” “location determination,” or the like. A location of UE 105 may comprise an absolute location of UE 105 (e.g. a latitude and longitude and possibly altitude) or a relative location of UE 105 (e.g. a location expressed as distances north or south, east or west and possibly above or below some other known fixed location (including, e.g., the location of a base station 120 or AP 130) or some other location such as a location for UE 105 at some known previous time, or a location of another UE 145 at some known previous time). A location may be specified as a geodetic location comprising coordinates which may be absolute (e.g. latitude, longitude and optionally altitude), relative (e.g. relative to some known absolute location) or local (e.g. X, Y and optionally Z coordinates according to a coordinate system defined relative to a local area such a factory, warehouse, college campus, shopping mall, sports stadium or convention center). A location may instead be a civic location and may then comprise one or more of a street address (e.g. including names or labels for a country, state, county, city, road and/or street, and/or a road or street number), and/or a label or name for a place, building, portion of a building, floor of a building, and/or room inside a building etc. A location may further include an uncertainty or error indication, such as a horizontal and possibly vertical distance by which the location is expected to be in error or an indication of an area or volume (e.g. a circle or ellipse) within which UE 105 is expected to be located with some level of confidence (e.g. 95% confidence).

The external client 180 may be a web server or remote application that may have some association with UE 105 (e.g. may be accessed by a user of UE 105) or may be a server, application, or computer system providing a location service to some other user or users which may include obtaining and providing the location of UE 105 (e.g. to enable a service such as friend or relative finder, asset tracking or child or pet location). Additionally or alternatively, the external client 180 may obtain and provide the location of UE 105 to an emergency services provider, government agency, etc.

As previously noted, the example positioning system 100 can be implemented using a wireless communication network, such as an LTE-based or 5G NR-based network. FIG. 2 shows a diagram of a 5G NR positioning system 200, illustrating an embodiment of a positioning system (e.g., positioning system 100) implementing 5G NR. The 5G NR positioning system 200 may be configured to determine the location of a UE 105 by using access nodes, which may include NR NodeB (gNB) 210-1 and 210-2 (collectively and generically referred to herein as gNBs 210), ng-eNB 214, and/or WLAN 216 to implement one or more positioning methods. The gNBs 210 and/or the ng-eNB 214 may correspond with base stations 120 of FIG. 1, and the WLAN 216 may correspond with one or more access points 130 of FIG. 1. Optionally, the 5G NR positioning system 200 additionally may be configured to determine the location of a UE 105 by using an LMF 220 (which may correspond with location server 160) to implement the one or more positioning methods. Here, the 5G NR positioning system 200 comprises a UE 105, and components of a 5G NR network comprising a Next Generation (NG) Radio Access Network (RAN) (NG-RAN) 235 and a 5G Core Network (5G CN) 240. A 5G network may also be referred to as an NR network; NG-RAN 235 may be referred to as a 5G RAN or as an NR RAN; and 5G CN 240 may be referred to as an NG Core network. The 5G NR positioning system 200 may further utilize information from GNSS satellites 110 from a GNSS system like Global Positioning System (GPS) or similar system (e.g. GLONASS, Galileo, Beidou, Indian Regional Navigational Satellite System (IRNSS)). Additional components of the 5G NR positioning system 200 are described below. The 5G NR positioning system 200 may include additional or alternative components.

It should be noted that FIG. 2 provides only a generalized illustration of various components, any or all of which may be utilized as appropriate, and each of which may be duplicated or omitted as necessary. Specifically, although only one UE 105 is illustrated, it will be understood that many UEs (e.g., hundreds, thousands, millions, etc.) may utilize the 5G NR positioning system 200. Similarly, the 5G NR positioning system 200 may include a larger (or smaller) number of GNSS satellites 110, gNBs 210, ng-eNBs 214, Wireless Local Area Networks (WLANs) 216, Access and mobility Management Functions (AMF)s 215, external clients 230, and/or other components. The illustrated connections that connect the various components in the 5G NR positioning system 200 include data and signaling connections which may include additional (intermediary) components, direct or indirect physical and/or wireless connections, and/or additional networks. Furthermore, components may be rearranged, combined, separated, substituted, and/or omitted, depending on desired functionality.

The UE 105 may comprise and/or be referred to as a device, a mobile device, a wireless device, a mobile terminal, a terminal, a mobile station (MS), a Secure User Plane Location (SUPL)-Enabled Terminal (SET), or by some other name. Moreover, UE 105 may correspond to a cellphone, smartphone, laptop, tablet, personal data assistant (PDA), navigation device, Internet of Things (IoT) device, or some other portable or moveable device. Typically, though not necessarily, the UE 105 may support wireless communication using one or more Radio Access Technologies (RATs) such as using GSM, CDMA, W-CDMA, LTE, High Rate Packet Data (HRPD), IEEE 802.11 Wi-Fi®, Bluetooth, Worldwide Interoperability for Microwave Access (WiMAX™), 5G NR (e.g., using the NG-RAN 235 and 5G CN 240), etc. The UE 105 may also support wireless communication using a WLAN 216 which (like the one or more RATs, and as previously noted with respect to FIG. 1) may connect to other networks, such as the Internet. The use of one or more of these RATs may allow the UE 105 to communicate with an external client 230 (e.g., via elements of 5G CN 240 not shown in FIG. 2, or possibly via a Gateway Mobile Location Center (GMLC) 225) and/or allow the external client 230 to receive location information regarding the UE 105 (e.g., via the GMLC 225). The external client 230 of FIG. 2 may correspond to external client 180 of FIG. 1, as implemented in or communicatively coupled with a 5G NR network.

The UE 105 may include a single entity or may include multiple entities, such as in a personal area network where a user may employ audio, video and/or data I/O devices, and/or body sensors and a separate wireline or wireless modem. An estimate of a location of the UE 105 may be referred to as a location, location estimate, location fix, fix, position, position estimate, or position fix, and may be geodetic, thus providing location coordinates for the UE 105 (e.g., latitude and longitude), which may or may not include an altitude component (e.g., height above sea level, height above or depth below ground level, floor level or basement level). Alternatively, a location of the UE 105 may be expressed as a civic location (e.g., as a postal address or the designation of some point or small area in a building such as a particular room or floor). A location of the UE 105 may also be expressed as an area or volume (defined either geodetically or in civic form) within which the UE 105 is expected to be located with some probability or confidence level (e.g., 67%, 95%, etc.). A location of the UE 105 may further be a relative location comprising, for example, a distance and direction or relative X, Y (and Z) coordinates defined relative to some origin at a known location which may be defined geodetically, in civic terms, or by reference to a point, area, or volume indicated on a map, floor plan or building plan. In the description contained herein, the use of the term location may comprise any of these variants unless indicated otherwise. When computing the location of a UE, it is common to solve for local X, Y, and possibly Z coordinates and then, if needed, convert the local coordinates into absolute ones (e.g. for latitude, longitude and altitude above or below mean sea level).

Base stations in the NG-RAN 235 shown in FIG. 2 may correspond to base stations 120 in FIG. 1 and may include gNBs 210. Pairs of gNBs 210 in NG-RAN 235 may be connected to one another (e.g., directly as shown in FIG. 2 or indirectly via other gNBs 210). The communication interface between base stations (gNBs 210 and/or ng-eNB 214) may be referred to as an Xn interface 237. Access to the 5G network is provided to UE 105 via wireless communication between the UE 105 and one or more of the gNBs 210, which may provide wireless communications access to the 5G CN 240 on behalf of the UE 105 using 5G NR. The wireless interface between base stations (gNBs 210 and/or ng-eNB 214) and the UE 105 may be referred to as a Uu interface 239. 5G NR radio access may also be referred to as NR radio access or as 5G radio access. In FIG. 2, the serving gNB for UE 105 is assumed to be gNB 210-1, although other gNBs (e.g. gNB 210-2) may act as a serving gNB if UE 105 moves to another location or may act as a secondary gNB to provide additional throughput and bandwidth to UE 105.

Base stations in the NG-RAN 235 shown in FIG. 2 may also or instead include a next generation evolved Node B, also referred to as an ng-eNB, 214. Ng-eNB 214 may be connected to one or more gNBs 210 in NG-RAN 235-e.g. directly or indirectly via other gNBs 210 and/or other ng-eNBs. An ng-eNB 214 may provide LTE wireless access and/or evolved LTE (eLTE) wireless access to UE 105. Some gNBs 210 (e.g. gNB 210-2) and/or ng-eNB 214 in FIG. 2 may be configured to function as positioning-only beacons which may transmit signals (e.g., Positioning Reference Signal (PRS)) and/or may broadcast assistance data to assist positioning of UE 105 but may not receive signals from UE 105 or from other UEs. Some gNBs 210 (e.g., gNB 210-2 and/or another gNB not shown) and/or ng-eNB 214 may be configured to function as detecting-only nodes may scan for signals containing, e.g., PRS data, assistance data, or other location data. Such detecting-only nodes may not transmit signals or data to UEs but may transmit signals or data (relating to, e.g., PRS, assistance data, or other location data) to other network entities (e.g., one or more components of 5G CN 240, external client 230, or a controller) which may receive and store or use the data for positioning of at least UE 105. It is noted that while only one ng-eNB 214 is shown in FIG. 2, some embodiments may include multiple ng-eNBs 214. Base stations (e.g., gNBs 210 and/or ng-eNB 214) may communicate directly with one another via an Xn communication interface. Additionally or alternatively, base stations may communicate directly or indirectly with other components of the 5G NR positioning system 200, such as the LMF 220 and AMF 215.

5G NR positioning system 200 may also include one or more WLANs 216 which may connect to a Non-3GPP InterWorking Function (N3IWF) 250 in the 5G CN 240 (e.g., in the case of an untrusted WLAN 216). For example, the WLAN 216 may support IEEE 802.11 Wi-Fi access for UE 105 and may comprise one or more Wi-Fi APs (e.g., APs 130 of FIG. 1). Here, the N3IWF 250 may connect to other elements in the 5G CN 240 such as AMF 215. In some embodiments, WLAN 216 may support another RAT such as Bluetooth. The N3IWF 250 may provide support for secure access by UE 105 to other elements in 5G CN 240 and/or may support interworking of one or more protocols used by WLAN 216 and UE 105 to one or more protocols used by other elements of 5G CN 240 such as AMF 215. For example, N3IWF 250 may support IPSec tunnel establishment with UE 105, termination of IKEv2/IPSec protocols with UE 105, termination of N2 and N3 interfaces to 5G CN 240 for control plane and user plane, respectively, relaying of uplink (UL) and downlink (DL) control plane Non-Access Stratum (NAS) signaling between UE 105 and AMF 215 across an N1 interface. In some other embodiments, WLAN 216 may connect directly to elements in 5G CN 240 (e.g. AMF 215 as shown by the dashed line in FIG. 2) and not via N3IWF 250. For example, direct connection of WLAN 216 to 5GCN 240 may occur if WLAN 216 is a trusted WLAN for 5GCN 240 and may be enabled using a Trusted WLAN Interworking Function (TWIF) (not shown in FIG. 2) which may be an element inside WLAN 216. It is noted that while only one WLAN 216 is shown in FIG. 2, some embodiments may include multiple WLANs 216.

Access nodes may comprise any of a variety of network entities enabling communication between the UE 105 and the AMF 215. As noted, this can include gNBs 210, ng-eNB 214, WLAN 216, and/or other types of cellular base stations. However, access nodes providing the functionality described herein may additionally or alternatively include entities enabling communications to any of a variety of RATs not illustrated in FIG. 2, which may include non-cellular technologies. Thus, the term “access node,” as used in the embodiments described herein below, may include but is not necessarily limited to a gNB 210, ng-eNB 214 or WLAN 216.

In some embodiments, an access node, such as a gNB 210, ng-eNB 214, and/or WLAN 216 (alone or in combination with other components of the 5G NR positioning system 200), may be configured to, in response to receiving a request for location information from the LMF 220, obtain location measurements of uplink (UL) signals received from the UE 105) and/or obtain downlink (DL) location measurements from the UE 105 that were obtained by UE 105 for DL signals received by UE 105 from one or more access nodes. As noted, while FIG. 2 depicts access nodes (gNB 210, ng-eNB 214, and WLAN 216) configured to communicate according to 5G NR, LTE, and Wi-Fi communication protocols, respectively, access nodes configured to communicate according to other communication protocols may be used, such as, for example, a Node B using a Wideband Code Division Multiple Access (WCDMA) protocol for a Universal Mobile Telecommunications Service (UMTS) Terrestrial Radio Access Network (UTRAN), an eNB using an LTE protocol for an Evolved UTRAN (E-UTRAN), or a Bluetooth® beacon using a Bluetooth protocol for a WLAN. For example, in a 4G Evolved Packet System (EPS) providing LTE wireless access to UE 105, a RAN may comprise an E-UTRAN, which may comprise base stations comprising eNBs supporting LTE wireless access. A core network for EPS may comprise an Evolved Packet Core (EPC). An EPS may then comprise an E-UTRAN plus an EPC, where the E-UTRAN corresponds to NG-RAN 235 and the EPC corresponds to 5GCN 240 in FIG. 2. The methods and techniques described herein for obtaining a civic location for UE 105 may be applicable to such other networks.

The gNBs 210 and ng-eNB 214 can communicate with an AMF 215, which, for positioning functionality, communicates with an LMF 220. The AMF 215 may support mobility of the UE 105, including cell change and handover of UE 105 from an access node (e.g., gNB 210, ng-eNB 214, or WLAN 216)of a first RAT to an access node of a second RAT. The AMF 215 may also participate in supporting a signaling connection to the UE 105 and possibly data and voice bearers for the UE 105. The LMF 220 may support positioning of the UE 105 using a CP location solution when UE 105 accesses the NG-RAN 235 or WLAN 216 and may support position procedures and methods, including UE assisted/UE based and/or network based procedures/methods, such as Assisted GNSS (A-GNSS), Observed Time Difference Of Arrival (OTDOA) (which may be referred to in NR as Time Difference Of Arrival (TDOA)), Real Time Kinematic (RTK), Precise Point Positioning (PPP), Differential GNSS (DGNSS), Enhance Cell ID (ECID), angle of arrival (AOA), angle of departure (AoD), WLAN positioning, round trip signal propagation delay (RTT), multi-cell RTT, and/or other positioning procedures and methods. The LMF 220 may also process location service requests for the UE 105, e.g., received from the AMF 215 or from the GMLC 225. The LMF 220 may be connected to AMF 215 and/or to GMLC 225. In some embodiments, a network such as 5GCN 240 may additionally or alternatively implement other types of location-support modules, such as an Evolved Serving Mobile Location Center (E-SMLC) or a SUPL Location Platform (SLP). It is noted that in some embodiments, at least part of the positioning functionality (including determination of a UE 105′s location) may be performed at the UE 105 (e.g., by measuring downlink PRS (DL-PRS) signals transmitted by wireless nodes such as gNBs 210, ng-eNB 214 and/or WLAN 216, and/or using assistance data provided to the UE 105, e.g., by LMF 220).

The Gateway Mobile Location Center (GMLC) 225 may support a location request for the UE 105 received from an external client 230 and may forward such a location request to the AMF 215 for forwarding by the AMF 215 to the LMF 220. A location response from the LMF 220 (e.g., containing a location estimate for the UE 105) may be similarly returned to the GMLC 225 either directly or via the AMF 215, and the GMLC 225 may then return the location response (e.g., containing the location estimate) to the external client 230.

A Network Exposure Function (NEF) 245 may be included in 5GCN 240. The NEF 245 may support secure exposure of capabilities and events concerning 5GCN 240 and UE 105 to the external client 230, which may then be referred to as an Access Function (AF) and may enable secure provision of information from external client 230 to 5GCN 240. NEF 245 may be connected to AMF 215 and/or to GMLC 225 for the purposes of obtaining a location (e.g. a civic location) of UE 105 and providing the location to external client 230.

As further illustrated in FIG. 2, the LMF 220 may communicate with the gNBs 210 and/or with the ng-eNB 214 using an NR Positioning Protocol annex (NRPPa) as defined in 3GPP Technical Specification (TS) 38.455. NRPPa messages may be transferred between a gNB 210 and the LMF 220, and/or between an ng-eNB 214 and the LMF 220, via the AMF 215. As further illustrated in FIG. 2, LMF 220 and UE 105 may communicate using an LTE Positioning Protocol (LPP) as defined in 3GPP TS 37.355. Here, LPP messages may be transferred between the UE 105 and the LMF 220 via the AMF 215 and a serving gNB 210-1 or serving ng-eNB 214 for UE 105. For example, LPP messages may be transferred between the LMF 220 and the AMF 215 using messages for service-based operations (e.g., based on the Hypertext Transfer Protocol (HTTP)) and may be transferred between the AMF 215 and the UE 105 using a 5G NAS protocol. The LPP protocol may be used to support positioning of UE 105 using UE assisted and/or UE based position methods such as A-GNSS, RTK, TDOA, multi-cell RTT, AoD, and/or ECID. The NRPPa protocol may be used to support positioning of UE 105 using network based position methods such as ECID, AOA, uplink TDOA (UL-TDOA) and/or may be used by LMF 220 to obtain location related information from gNBs 210 and/or ng-eNB 214, such as parameters defining DL-PRS transmission from gNBs 210 and/or ng-eNB 214.

In the case of UE 105 access to WLAN 216, LMF 220 may use NRPPa and/or LPP to obtain a location of UE 105 in a similar manner to that just described for UE 105 access to a gNB 210 or ng-eNB 214. Thus, NRPPa messages may be transferred between a WLAN 216 and the LMF 220, via the AMF 215 and N3IWF 250 to support network-based positioning of UE 105 and/or transfer of other location information from WLAN 216 to LMF 220. Alternatively, NRPPa messages may be transferred between N3IWF 250 and the LMF 220, via the AMF 215, to support network-based positioning of UE 105 based on location related information and/or location measurements known to or accessible to N3IWF 250 and transferred from N3IWF 250 to LMF 220 using NRPPa. Similarly, LPP and/or LPP messages may be transferred between the UE 105 and the LMF 220 via the AMF 215, N3IWF 250, and serving WLAN 216 for UE 105 to support UE assisted or UE based positioning of UE 105 by LMF 220.

In a 5G NR positioning system 200, positioning methods can be categorized as being “UE assisted” or “UE based.” This may depend on where the request for determining the position of the UE 105 originated. If, for example, the request originated at the UE (e.g., from an application, or “app,” executed by the UE), the positioning method may be categorized as being UE based. If, on the other hand, the request originates from an external client or AF 230, LMF 220, or other device or service within the 5G network, the positioning method may be categorized as being UE assisted (or “network-based”).

With a UE-assisted position method, UE 105 may obtain location measurements and send the measurements to a location server (e.g., LMF 220) for computation of a location estimate for UE 105. For RAT-dependent position methods location measurements may include one or more of a Received Signal Strength Indicator (RSSI), Round Trip signal propagation Time (RTT), Reference Signal Received Power (RSRP), Reference Signal Received Quality (RSRQ), Reference Signal Time Difference (RSTD), Time of Arrival (TOA), AOA, Receive Time-Transmission Time Difference (Rx-Tx), Differential AOA (DAOA), AOD, or Timing Advance (TA) for gNBs 210, ng-eNB 214, and/or one or more access points for WLAN 216. Additionally or alternatively, similar measurements may be made of sidelink signals transmitted by other UEs, which may serve as anchor points for positioning of the UE 105 if the positions of the other UEs are known. The location measurements may also or instead include measurements for RAT-independent positioning methods such as GNSS (e.g., GNSS pseudorange, GNSS code phase, and/or GNSS carrier phase for GNSS satellites 110), WLAN, etc.

With a UE-based position method, UE 105 may obtain location measurements (e.g., which may be the same as or similar to location measurements for a UE assisted position method) and may further compute a location of UE 105 (e.g., with the help of assistance data received from a location server such as LMF 220, an SLP, or broadcast by gNBs 210, ng-eNB 214, or WLAN 216).

With a network based position method, one or more base stations (e.g., gNBs 210 and/or ng-eNB 214), one or more APs (e.g., in WLAN 216), or N3IWF 250 may obtain location measurements (e.g., measurements of RSSI, RTT, RSRP, RSRQ, AOA, or TOA) for signals transmitted by UE 105, and/or may receive measurements obtained by UE 105 or by an AP in WLAN 216 in the case of N3IWF 250, and may send the measurements to a location server (e.g., LMF 220) for computation of a location estimate for UE 105.

Positioning of the UE 105 also may be categorized as UL, DL, or DL-UL based, depending on the types of signals used for positioning. If, for example, positioning is based solely on signals received at the UE 105 (e.g., from a base station or other UE), the positioning may be categorized as DL based. On the other hand, if positioning is based solely on signals transmitted by the UE 105 (which may be received by a base station or other UE, for example), the positioning may be categorized as UL based. Positioning that is DL-UL based includes positioning, such as RTT-based positioning, that is based on signals that are both transmitted and received by the UE 105. Sidelink (SL)-assisted positioning comprises signals communicated between the UE 105 and one or more other UEs. According to some embodiments, UL, DL, or DL-UL positioning as described herein may be capable of using SL signaling as a complement or replacement of SL, DL, or DL-UL signaling.

Depending on the type of positioning (e.g., UL, DL, or DL-UL based) the types of reference signals used can vary. For DL-based positioning, for example, these signals may comprise PRS (e.g., DL-PRS transmitted by base stations or SL-PRS transmitted by other UEs), which can be used for TDOA, AoD, and RTT measurements. Other reference signals that can be used for positioning (UL, DL, or DL-UL) may include Sounding Reference Signal (SRS), Channel State Information Reference Signal (CSI-RS), synchronization signals (e.g., synchronization signal block (SSB) Synchronizations Signal (SS)), Physical Uplink Control Channel (PUCCH), Physical Uplink Shared Channel (PUSCH), Physical Sidelink Shared Channel (PSSCH), Demodulation Reference Signal (DMRS), etc. Moreover, reference signals may be transmitted in a Tx beam and/or received in an Rx beam (e.g., using beamforming techniques), which may impact angular measurements, such as AOD or AOA.

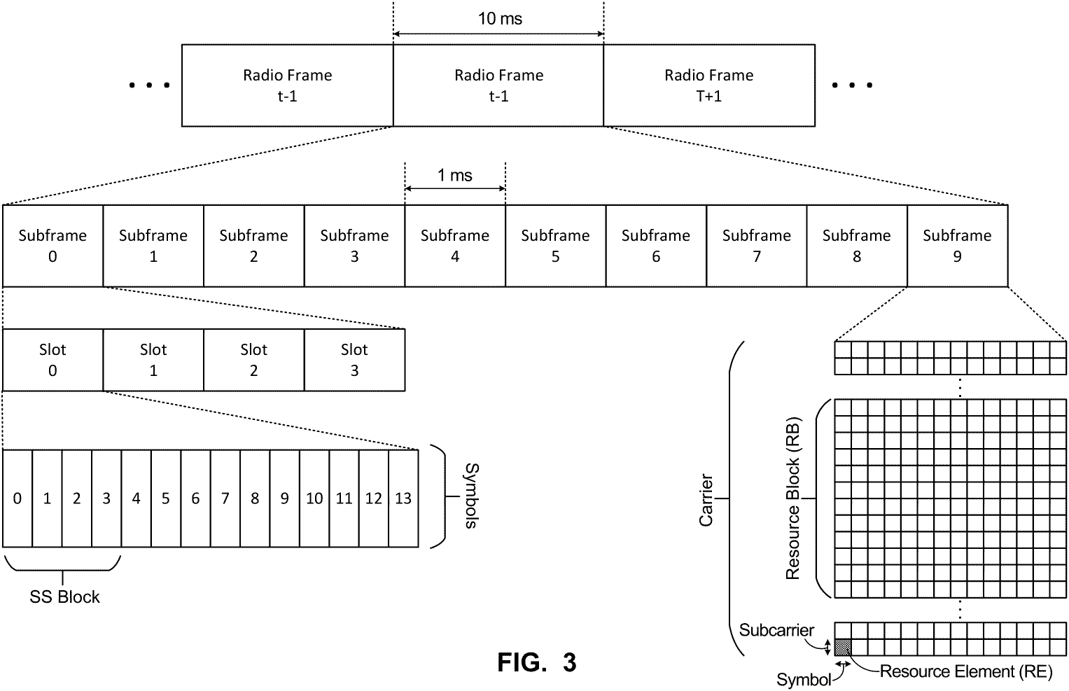

FIG. 3 is a diagram showing an example of a frame structure 300 for NR and associated terminology, which can serve as the basis for physical layer communication between the UE 105 and base stations/TRPs, such as serving gNB 210-1. The transmission timeline for each of the downlink and uplink may be partitioned into units of radio frames. Each radio frame may have a predetermined duration (e.g., 10 ms) and may be partitioned into 10 subframes, each of 1 ms, with indices of 0 through 9. Each subframe may include a variable number of slots depending on the subcarrier spacing. Each slot may include a variable number of symbol periods (e.g., 7 or 14 symbols) depending on the subcarrier spacing. The symbol periods in each slot may be assigned indices. A mini slot may comprise a sub slot structure (e.g., 2, 3, or 4 symbols). Additionally shown in FIG. 3 is the complete Orthogonal Frequency-Division Multiplexing (OFDM) of a subframe, showing how a subframe can be divided across both time and frequency into a plurality of Resource Blocks (RBs). A single RB can comprise a grid of Resource Elements (REs) spanning 14 symbols and 12 subcarriers.

Each symbol in a slot may indicate a link direction (e.g., downlink (DL), uplink (UL), or flexible) or data transmission and the link direction for each subframe may be dynamically switched. The link directions may be based on the slot format. Each slot may include DL/UL data as well as DL/UL control information. In NR, a synchronization signal (SS) block is transmitted. The SS block includes a primary SS (PSS), a secondary SS (SSS), and a two symbol Physical Broadcast Channel (PBCH). The SS block can be transmitted in a fixed slot location, such as the symbols 0-3 as shown in FIG. 3. The PSS and SSS may be used by UEs for cell search and acquisition. The PSS may provide half-frame timing, the SS may provide the cyclic prefix (CP) length and frame timing. The PSS and SSS may provide the cell identity. The PBCH carries some basic system information, such as downlink system bandwidth, timing information within radio frame, SS burst set periodicity, system frame number, etc.

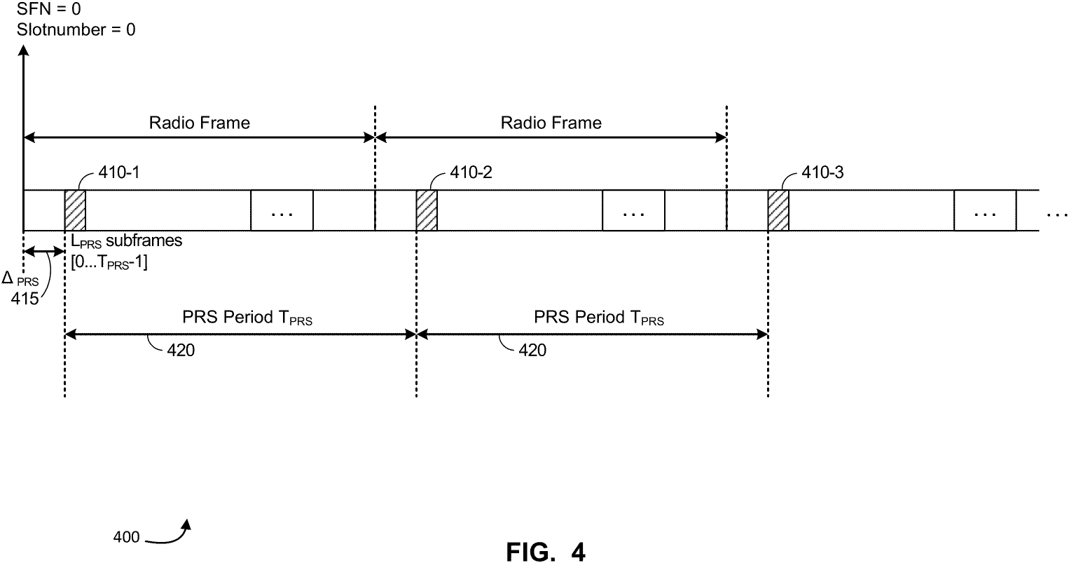

FIG. 4 is a diagram showing an example of a radio frame sequence 400 with PRS positioning occasions. A “PRS instance” or “PRS occasion” is one instance of a periodically repeated time window (e.g., a group of one or more consecutive slots) where PRS are expected to be transmitted. A PRS occasion may also be referred to as a “PRS positioning occasion,” a “PRS positioning instance”, a “positioning occasion,” “a positioning instance,” or simply an “occasion” or “instance.” Subframe sequence 400 may be applicable to broadcast of PRS signals (DL-PRS signals) from base stations 120 in positioning system 100. The radio frame sequence 400 may be used in 5G NR (e.g., in 5G NR positioning system 200) and/or in LTE. Similar to FIG. 3, time is represented horizontally (e.g., on an X axis) in FIG. 4, with time increasing from left to right. Frequency is represented vertically (e.g., on a Y axis) with frequency increasing (or decreasing) from bottom to top.

FIG. 4 shows how PRS positioning occasions 410-1, 410-2, and 410-3 (collectively and generically referred to herein as positioning occasions 410) are determined by a System Frame Number (SFN), a cell-specific subframe offset (Δ_{PRS}) 415, a length (or span) of L_{PRS} subframes, and the PRS Periodicity (T_{PRS}) 420. The cell-specific PRS subframe configuration may be defined by a “PRS Configuration Index,” I_{PRS}, included in assistance data (e.g., TDOA assistance data), which may be defined by governing 3GPP standards. The cell-specific subframe offset (Δ_{PRS}) 415 may be defined in terms of the number of subframes transmitted starting from System Frame Number (SFN) 0 to the start of the first (subsequent) PRS positioning occasion.

A PRS may be transmitted by wireless nodes (e.g., base stations 120 or other UEs) after appropriate configuration (e.g., by an Operations and Maintenance (O&M) server). A PRS may be transmitted in special positioning subframes or slots that are grouped into positioning occasions 410. For example, a PRS positioning occasion 410-1 can comprise a number N_{PRS} of consecutive positioning subframes where the number N_{PRS} may be between 1 and 160 (e.g., may include the values 1, 2, 4 and 6 as well as other values). PRS occasions 410 may be grouped into one or more PRS occasion groups. As noted, PRS positioning occasions 410 may occur periodically at intervals, denoted by a number T_{PRS}, of millisecond (or subframe) intervals where T_{PRS} may equal 5, 10, 20, 40, 80, 160, 320, 640, or 1280 (or any other appropriate value). In some aspects, T_{PRS} may be measured in terms of the number of subframes between the start of consecutive positioning occasions.

In some aspects, when a UE 105 receives a PRS configuration index I_{PRS} in the assistance data for a particular cell (e.g., base station), the UE 105 may determine the PRS periodicity T_{PRS} 420 and cell-specific subframe offset (Δ_{PRS}) 415 using stored indexed data. The UE 105 may then determine the radio frame, subframe, and slot when a PRS is scheduled in the cell. The assistance data may be determined by, for example, a location server (e.g., location server 160 in FIG. 1 and/or LMF 220 in FIG. 2), and includes assistance data for a reference cell, and a number of neighbor cells supported by various wireless nodes.

Typically, PRS occasions from all cells in a network that use the same frequency are aligned in time and may have a fixed known time offset (e.g., cell-specific subframe offset (Δ_{PRS}) 415) relative to other cells in the network that use a different frequency. In SFN-synchronous networks all wireless nodes (e.g., base stations 120) may be aligned on both frame boundary and system frame number. Therefore, in SFN-synchronous networks all cells supported by the various wireless nodes may use the same PRS configuration index for any particular frequency of PRS transmission. On the other hand, in SFN-asynchronous networks, the various wireless nodes may be aligned on a frame boundary, but not system frame number. Thus, in SFN-asynchronous networks the PRS configuration index for each cell may be configured separately by the network so that PRS occasions align in time. A UE 105 may determine the timing of the PRS occasions 410 of the reference and neighbor cells for TDOA positioning, if the UE 105 can obtain the cell timing (e.g., SFN or Frame Number) of at least one of the cells, e.g., the reference cell or a serving cell. The timing of the other cells may then be derived by the UE 105 based, for example, on the assumption that PRS occasions from different cells overlap.

With reference to the frame structure in FIG. 3, a collection of REs that are used for transmission of PRS is referred to as a “PRS resource.” The collection of resource elements can span multiple RBs in the frequency domain and one or more consecutive symbols within a slot in the time domain, inside which pseudo-random Quadrature Phase Shift Keying (QPSK) sequences are transmitted from an antenna port of a TRP. In a given OFDM symbol in the time domain, a PRS resource occupies consecutive RBs in the frequency domain. The transmission of a PRS resource within a given RB has a particular combination, or “comb,” size. (Comb size also may be referred to as the “comb density.”) A comb size “N” represents the subcarrier spacing (or frequency/tone spacing) within each symbol of a PRS resource configuration, where the configuration uses every Nth subcarrier of certain symbols of an RB. For example, for comb-4, for each of the four symbols of the PRS resource configuration, REs corresponding to every fourth subcarrier (e.g., subcarriers 0, 4, 8) are used to transmit PRS of the PRS resource. Comb sizes of comb-2, comb-4, comb-6, and comb-12, for example, may be used in PRS.

A “PRS resource set” comprises a group of PRS resources used for the transmission of PRS signals, where each PRS resource has a PRS resource ID. In addition, the PRS resources in a PRS resource set are associated with the same TRP. A PRS resource set is identified by a PRS resource set ID and is associated with a particular TRP (identified by a cell ID). A “PRS resource repetition” is a repetition of a PRS resource during a PRS occasion/instance. The number of repetitions of a PRS resource may be defined by a “repetition factor” for the PRS resource. In addition, the PRS resources in a PRS resource set may have the same periodicity, a common muting pattern configuration, and the same repetition factor across slots. The periodicity may have a length selected from 2^{m}•{4, 5, 8, 10, 16, 20, 32, 40, 64, 80, 160, 320, 640, 1280, 2560, 5120, 10240} slots, with µ = 0, 1, 2, 3. The repetition factor may have a length selected from {1, 2, 4, 6, 8, 16, 32} slots.

A PRS resource ID in a PRS resource set may be associated with a single beam (and/or beam ID) transmitted from a single TRP (where a TRP may transmit one or more beams). That is, each PRS resource of a PRS resource set may be transmitted on a different beam, and as such, a PRS resource (or simply “resource”) can also be referred to as a “beam.” Note that this does not have any implications on whether the TRPs and the beams on which PRS are transmitted are known to the UE.

In the 5G NR positioning system 200 illustrated in FIG. 2, a TRP (gNB 210, ng-eNB 214, and/or WLAN 216)may transmit frames, or other physical layer signaling sequences, supporting PRS signals (i.e. a DL-PRS) according to frame configurations as previously described, which may be measured and used for position determination of the UE 105. As noted, other types of wireless network nodes, including other UEs, may also be configured to transmit PRS signals configured in a manner similar to (or the same as) that described above. Because transmission of a PRS by a wireless network node may be directed to all UEs within radio range, the wireless network node may be considered to transmit (or broadcast) a PRS.

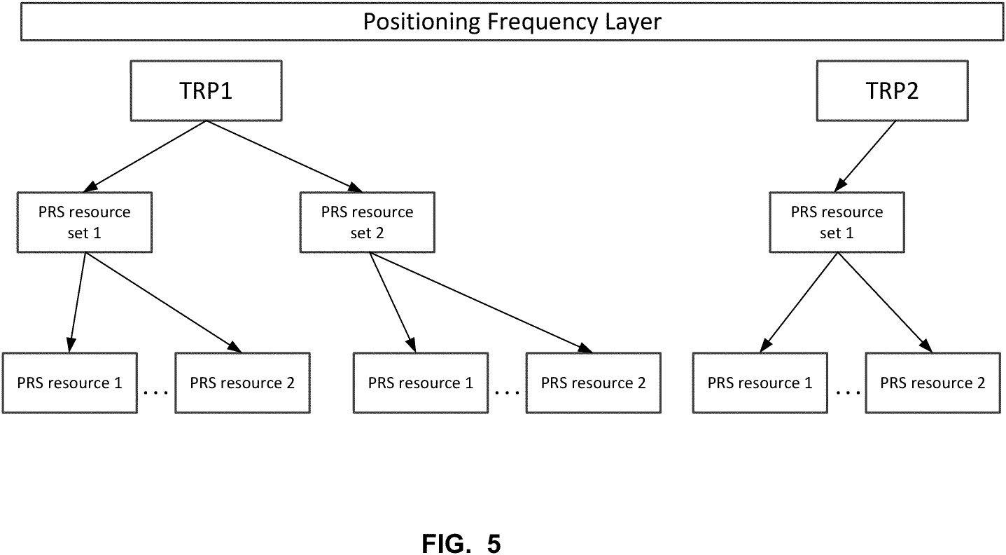

FIG. 5 is a diagram of a hierarchical structure of how PRS resources and PRS resource sets may be used by different TRPs of a given position frequency layer (PFL), as defined in 5G NR. With respect to a network (Uu) interface, a UE 105 can be configured with one or more DL-PRS resource sets from each of one or more TRPs. Each DL-PRS resource set includes K ≥ 1 DL-PRS resource(s), which, as previously noted, may correspond to a Tx beam of the TRP. A DL-PRS PFL is defined as a collection of DL-PRS resource sets which have the same subcarrier spacing (SCS) and cyclic prefix (CP) type, the same value of DL-PRS bandwidth, the same center frequency, and the same value of comb size. In current iterations of the NR standard, a UE 105 can be configured with up to four DL-PRS PFLs.

NR has multiple frequency bands across different frequency ranges (e.g., Frequency Range 1 (FR1) and Frequency Range 2 (FR2)). PFLs may be on the same band or different bands. In some embodiments, they may even be in different frequency ranges. Additionally, as illustrated in FIG. 5, multiple TRPs (e.g., TRP1 and TR2) may be on the same PFL. Currently under NR, each TRP can have up to two PRS resource sets, each with one or more PRS resources, as previously described.

Different PRS resource sets may have different periodicity. For example, one PRS resource set may be used for tracking, and another PRS resource that could be used for acquisition. Additionally or alternatively, one PRS resource set may have more beams, and another may have fewer beams. Accordingly, different resource sets may be used by a wireless network for different purposes.

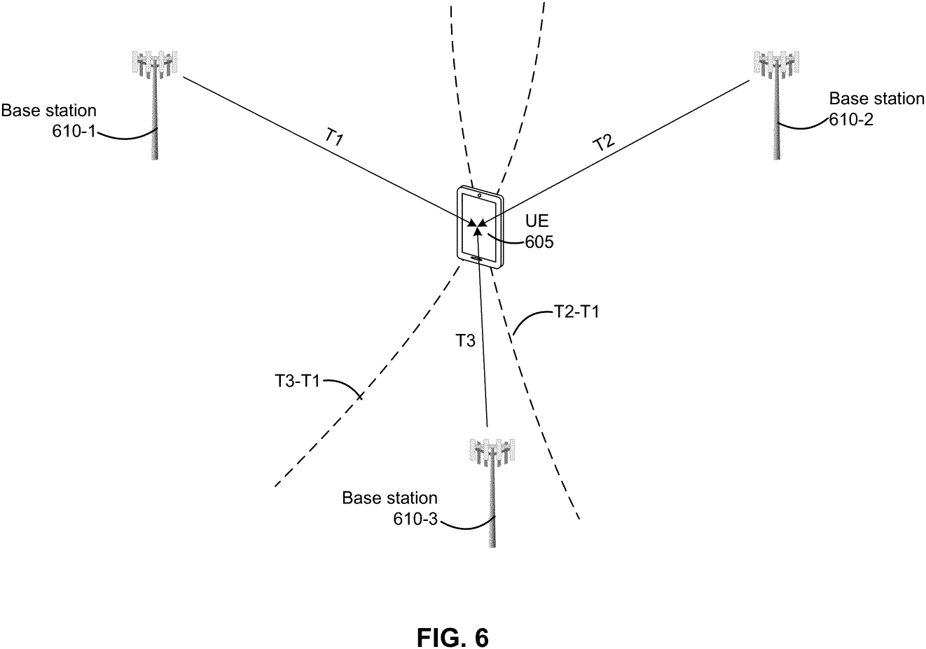

FIG. 6 is an illustration how OTDOA-based positioning (also known as downlink time difference of arrival (DL-TDOA)) can be made, according to some embodiments. In brief, OTDOA-based positioning is positioning made based on known positions of base stations (e.g., base stations 610, 610-2, and 610-3, collectively and generically referred to herein as base stations 610, which may correspond to other base stations and/or TRPs described herein), known times at which base stations transmit respective reference signals (e.g., PRS), and differences in times at which the UE 605 (which may correspond to other UEs described herein) receives the reference signals from each base station.

In OTDOA-based positioning, a location server may provide OTDOA assistance data to a UE 605 for a reference base station (which may be called a “reference cell” or “reference resource”), and one or more neighboring base stations (which may be called “neighbor cells” or “neighboring cells”, and which individually may be called a “target cell” or “target resource”) relative to the reference base station. For example, the assistance data may provide the center channel frequency of each base station, various PRS configuration parameters (e.g., N_{PRS}, T_{PRS}, muting sequence, frequency hopping sequence, PRS ID, PRS bandwidth), a base station (cell) global ID, PRS signal characteristics associated with a directional PRS, and/or other base station related parameters applicable to OTDOA or some other position method. OTDOA-based positioning by a UE 605 may be facilitated by indicating the serving base station for the UE 605 in the OTDOA assistance data (e.g., with the reference base station indicated as being the serving base station). In some aspects, OTDOA assistance data may also include “expected Reference Signal Time Difference (RSTD)” parameters, which provide the UE 605 with information about the RSTD values the UE 605 is expected to measure at its current location between the reference base station and each neighbor base station, together with an uncertainty of the expected RSTD parameter. The expected RSTD, together with the associated uncertainty, may define a search window for the UE 605 within which the UE 605 is expected to measure the RSTD value. OTDOA assistance information may also include PRS configuration information parameters, which allow a UE 105 to determine when a PRS positioning occasion occurs on signals received from various neighbor base stations relative to PRS positioning occasions for the reference base station, and to determine the PRS sequence transmitted from various base stations in order to measure a time of arrival (TOA) or RSTD. TOA measurements may be RSRP (Reference Signal Receive Power) measurements of average power of Resource Elements (RE) that carry PRS (or other reference signals).

Using the RSTD measurements, the known absolute or relative transmission timing of each base station, and the known position(s) of wireless node physical transmitting antennas for the reference and neighboring base stations, the UE position may be calculated (e.g., by the UE 605 or by a location server). More particularly, the RSTD for a neighbor base station “k” relative to a reference base station “Ref,” may be given as the difference in TOA measurements of signals from each base station (i.e., TOAₖ- TOA_{Ref}), where the TOA values may be measured modulo one subframe duration (1 ms) to remove the effects of measuring different subframes at different times. In FIG. 6, for example, a first base station 610-1 may be designated as the reference base station, and second and third base stations (610-2 and 610-3) are neighbor base stations. If UE 605 receives reference signals from first base station 610-1, second base station 610-2, and third base station 610-3 at times T1, T2, and T2, respectively, then the RSTD measurement for second base station 610-2 would be determined as T2-T1 and the RSTD measurement for third base station 610-3 would be determined as T3-T1. RSTD measurements can be used by the UE 605 and/or sent to a location server to determine the location of the UE 605 using (i) the RSTD measurements, (ii) the known absolute or relative transmission timing of each base station, (iii) the known position(s) of base stations 610 for the reference and neighboring base stations, and/or (iv) directional PRS characteristics such as a direction of transmission. Geometrically, information (i)-(iv) allows for possible locations of the UE 605 to be determined for each RSTD (where each RSTD results in a hyperbola, as shown in FIG. 6), and the position of the UE 605 to be determined from the intersection of the possible locations for all RSTDs.

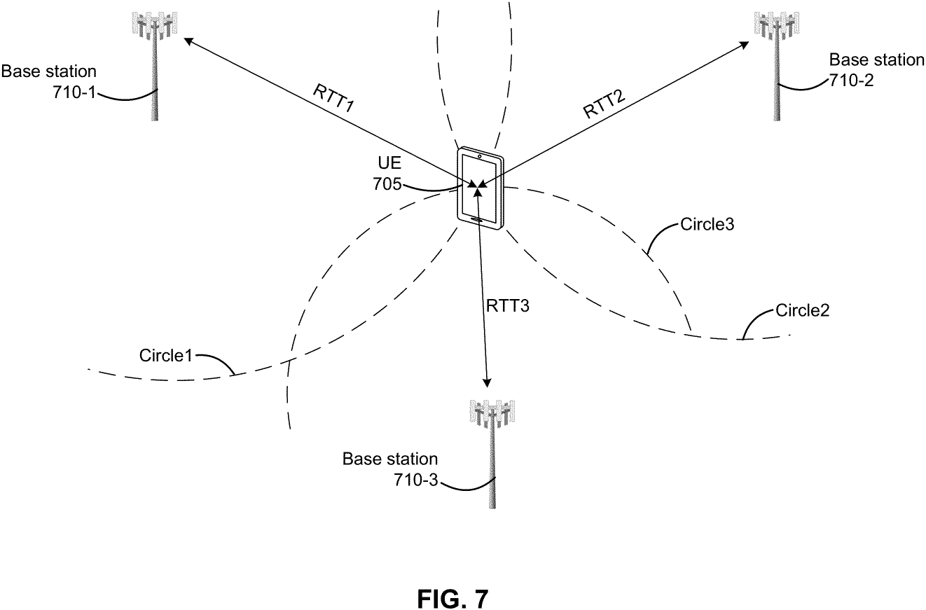

FIG. 7 is an illustration how RTT-based positioning (or multi-RTT) can be made, according to some embodiments. In brief, RTT-based positioning includes positioning methods in which the position of the UE 705 (which may correspond to other UEs described herein) is determined based on known positions of base stations (e.g., base stations 710, again which may correspond to other base stations and/or TRPs described herein), and known distances between the UE 705 and the base stations. RTT measurements between the UE 705 and each base station are used to determine a distance between the UE 705 and the respective base station, and multilateration can be used to determine the location of the UE 705.

In RTT-based positioning, a location server may coordinate RTT measurements between the UE 705 and each base station. Information provided to the UE 705 may be included in RTT assistance data. This can include, for example, reference signal (e.g., PRS) timing and other signal characteristics, base station (cell) ID, and/or other base station related parameters applicable to multi-RTT or some other position method. Depending on desired functionality, RTT measurements may be made (and initiated by) the UE 705 or a base station 710.

RTT measurements measure distance using Over The Air (OTA) delay. An initiating device (e.g., the UE 705 or a base station 710) transmits a first reference signal at first time, T1, which propagates to a responding device. At a second time, T2, the first reference signal arrives at the responding device. The OTA delay (i.e., the propagation time it takes for the first reference signal to travel from the initiating device to the responding device) is the difference between T1 and T2. The responding device then transmits a second reference signal at a third time, T3, and the second reference signal is received and measured by the initiating device at a fourth time, T4. RSRP measurements may be used to determine TOA for times T2 and T4. Distance, d, between the initiating and responding devices therefore can be determined using the following equation:

$$\frac{2 d}{c} = \left({T}_{4} - {T}_{1}\right) - \left({T}_{3} - {T}_{2}\right) = \left({T}_{4} - {T}_{1}\right) + \left({T}_{2} - {T}_{3}\right) . \qquad \text{(1)}$$

(As will be appreciated, distance, d, divided by the speed of RF propagation, c, equals the OTA delay.) Thus, a precise determination of the distance between the initiating device and responding device can be made.

RTT measurements between the UE 705 and base stations 710 can therefore allow the position of the UE 705 to be determined using multilateration. That is, RTT measurements between the UE 705 and the first base station 710-1, second base station 210-2, and third base station 710-3 (RTT measurements RTT1, RTT2, and RTT3, respectively) result in a determination of the distance of the UE 705 from each of the base stations 710. These distances can be used to trace circles around known positions of the base stations 710 (where Circle1 corresponds to base station 701-1, Circle2 corresponds to base station 701-2, and Circle3 corresponds to base station 701-3.) The position of the UE 705 can be determined as the intersection between the circles.

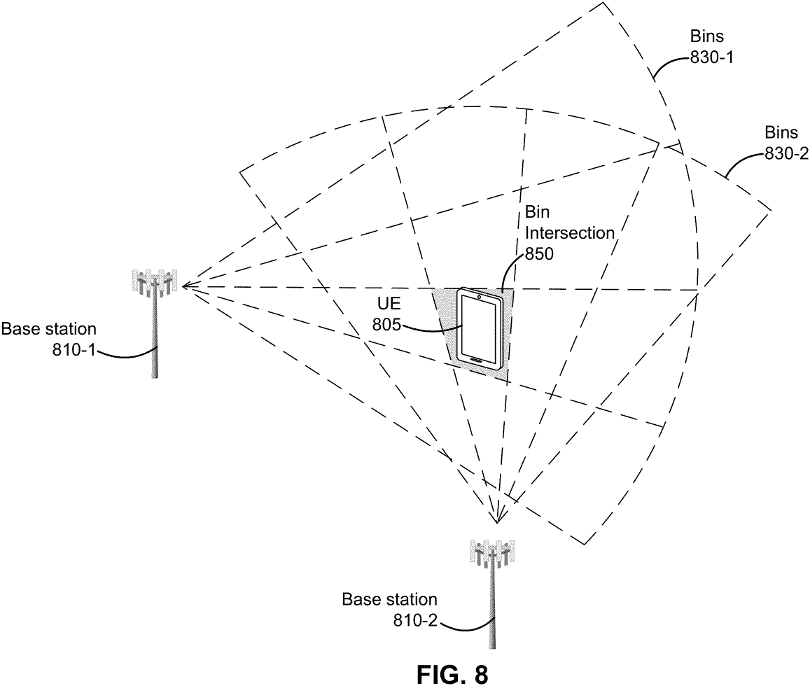

FIG. 8 is an illustration how AOD-based positioning (or DL-AOD) can be made, according to some embodiments. In brief, AOD-based positioning is positioning made based on reference signals (e.g., PRS) received by the UE 805 (again, which may correspond to other UEs described herein), transmitted by certain beams of the base stations 810 (again which may correspond to other base stations and/or TRPs described herein), and a corresponding coverage area covered by the beams.

In AOD-based positioning, a location server may provide AOD assistance data to a UE 805. This assistance data, which may be based on an approximate location of the UE 805, may provide information regarding reference signals for nearby base stations 810, including center channel frequency of each base station, various PRS configuration parameters (e.g., N_{PRS}, T_{PRS}, muting sequence, frequency hopping sequence, PRS ID, PRS bandwidth, beam ID), a base station (cell) global ID, PRS signal characteristics associated with a directional PRS, and/or other base station related parameters applicable to DOA or some other position method.

Using this information, the UE 805 and/or location server can determine the UE’s location by the beam(s) with which the UE 805 detects a PRS from each base station 810. More specifically, PRS from a base station 810 is transmitted via a beam centered along angular regions, or bins 830. Thus, each bin 830 can correspond to a PRS from a different respective beam. Bins 830 from different base stations 810 can form an angular grid that can be used to determine the location of the UE 805. For example, as illustrated in FIG. 3, bins 830-1 of base station 810-1 intersect with bins 830-2 of base station 810-2 to form an angular grid. The UE 805 can measure (e.g., using RSRP measurements) the PRS of different beams of each base station 810. These measurements can be used by the UE 805 or sent to the location server to determine the location of the UE 805 from the corresponding bin intersection 850, where the bin 830-1 corresponding to the PRS of a first base station 810-1 intersects with the bin 830-2 corresponding to the PRS of a second base station 810-2. Similar measurements can be made from additional base stations (not shown) to provide additional accuracy. Additionally or alternatively, measurements from multiple beams of a single base station 810 can enable interpolation for higher-resolution positioning.

As previously indicated, periodic DL-PRS (e.g., provided in the manner indicated in FIG. 4) may enable the UE to know when TRPs transmit PRS based on a known periodicity for the DL-PRS. On the other hand, for aperiodic DL-PRS, or AP-PRS, the network may need to provide information regarding the transmittal of AP-PRS by one or more network nodes to the UE, “triggering” the network node to monitor the PRS (e.g., a “trigger command”) and/or report measurement information (e.g., a “positioning measurement request command”). Such triggering can be evoked for UE-based and/or network-based positioning and may be prompted by an external entity (e.g., in an emergency response center). In such instances, the LMF may provide the UE with DL-PRS configuration via Radio Resource Control (RRC) or LPP. Additionally or alternatively, a serving gNB (e.g., gNB 210-1 of FIG. 2) may trigger the UE via a Medium Access Control-Control Element (MAC-CE) configuration, or a Downlink Control Information (DCI) configuration, and because non-serving gNBs to trigger their DL-PRS by communicating with them via an Xn interface or the LMF 220. Thus, by triggering non-serving gNBs to transmit AP-PRS (as well as transmitting its own AP-PRS) and triggering the UE ahead of time to monitor AP-PRS from the various gNBs, a serving gNB can orchestrate AP-PRS for the UE.

According to embodiments herein, AP-PRS can be triggered for multiple UEs using group common DCI. As a person of ordinary skill in the art will appreciate, DCI is carried from a gNB to a UE via a Physical Downlink Control Channel (PDCCH) provided in a control resource set (CORESET). Group common DCI is DCI provided in a search space to a group of one or more UEs. Thus, a gNB may use group common DCI to trigger multiple UEs at to monitor AP-PRS (which is broadcast) from multiple gNBs at once, which often can be a more effective/efficient way of triggering AP-PRS for multiple UEs than using periodic DL-PRS.

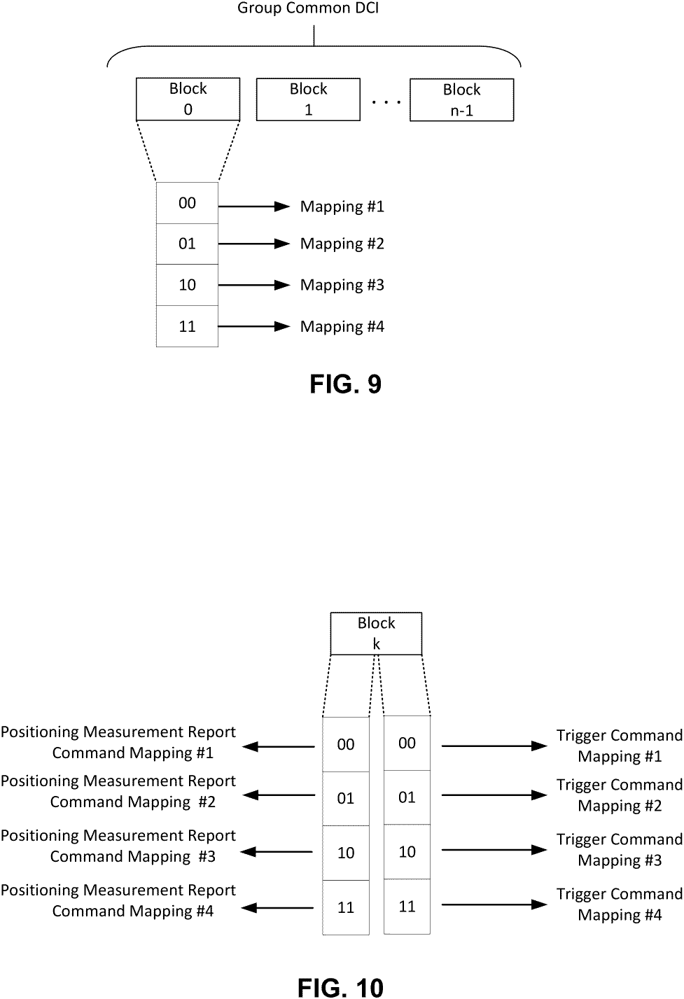

FIG. 9 is a diagram that illustrates the structure of a group common DCI, according to an embodiment. Here, the group common DCI can be broken into n data blocks (also referred to herein simply as “blocks”), where each data block comprises a set of one or more bits that convey information to the UE group, triggering one or more UEs of the group to monitor AP-PRS based at least in part on the group common DCI. It can be noted that, although the data blocks illustrated in FIG. 9 comprise two bits (resulting in four different options), alternative embodiments may comprise a larger or smaller number of bits. Further, as detailed below, the number of data blocks may vary, depending on the format used and the amount of information to be conveyed. Additionally, according to some embodiments, the mapping of the bits may be provided in a governing specification (e.g., fixed in accordance with the type of group common DCI format used), or may be dynamically determined and provided to the UE group separately from the DCI.

Generally put, embodiments herein can utilize group common DCI to transmit a group of AP-PRS trigger commands and/or a commands. AP-PRS trigger commands can trigger each UE to monitor one or more cells/TRPs for AP-PRS. In other words, the AP-PRS trigger commands indicate to the UEs which TRPs have been triggered to provide AP-PRS. Positioning measurement request commands can indicate to each UE information for the UE to provide back to the network (e.g., LMF 220) for positioning of the respective UE. In some embodiments, the group common DCI may further comprise a location report request command, which can include AP-PRS-related measurements already taken by the UE.

Each UE of the UE group to which the group common DCI can be configured to receive one or more blocks of the group common DCI. For example, a first UE of the group receive blocks 1 and 2, a second UE of the group may receive block 2 only, a third UE of the group may receive blocks 1, 4, and 5, etc. And thus, each UE may be configured differently, depending on desired functionality. An indication of which block(s) in the DCI a UE is to monitor may be indicated with a “startingBitIndex” in a monitoring set provided to the UE. According to some embodiments, not only may each UE receive more than one block, but each block may be received by more than one UE, depending on desired functionality. UEs may be configured via RRC, LPP, or MAC-CE.

The number of blocks, n, in the group common DCI may be limited based on size limits for the DCI. For example, for DCI limited to 128 bits where each block comprises two bits, the number of blocks would be limited to 64. Again, the number of blocks may be further limited based on format type used and/or other factors.

A listing of example format types used for providing AP-PRS trigger commands provided in Table 1:

TABLE 1

| Format Type | Bit Mapping |
|---|---|
| 1 | PFL(s) |
| 2 | PRS-ID(s) |
| 3 | Resource Set ID(s) |
| 4 | Resource ID(s) |
| 5 | PFL(s) + PRS-ID(s) + Resource Set ID(s) + Resource ID(s) |

Format type 1 comprises bit mapping to one or more PFLs. That is, each block includes bits indicative of a set of one or more PFLs with which the AP-PRS is transmitted by a TRP. Again, different UEs in the group may be configured to receive different blocks, and therefore may be configured to receive AP-PRS on different PFLs. When receiving the DCI, a UE can assume that all PRS resources of the triggered PFLs are triggered. An example mapping of a 2-bit block to PFLs using format type 1 could be as follows: bits “00” mean no AP-PRS triggering, bits “01” map to PFL1 and PFL2, bits “10” map to PFL2 and PFL3, and bits “11” map to PFL0. If the number, n, of blocks matches the number of UEs, each UE can then be individually configured with a set of PFLs (e.g., blocks may be mapped to UEs). That said, UEs may receive multiple blocks, providing additional configurability under format type 1.

Format type 2 comprises bit mapping to one or more PRS identifiers (PRS-IDs). Using this format type, different blocks of the group common DCI may correspond to different PFLs, and bits may be used to identify which TRP is will transmit PRS, based on the PRS-ID identified by the bits. Each PRS has its own timing (slot offset, etc.) so a receiving UE will know when to monitor for the AP-PRS, given the PRS ID. An example of mapping a two-bit block to PRS-IDs using format type 2 could be as follows: block 0 maps to PFL0 and has a bit mapping where bits “01” map to PRS-ID = 5, bits “10” map to PRS-ID = 10, and bits “11” map to PRS-ID = 1 and PRS-ID = 2; and block 1 maps to PFL1 and has the same bit mapping. In alternative embodiments, bit mapping for different blocks may be different.

Format type 3 comprises bit mapping to one or more PRS resource sets. Using this format type, different blocks of the group common DCI may be configured to be associated with one or more PRS-IDs (e.g., one or more TRPs), and bits may be used to identify which PRS resource set will be used by the TRP corresponding to the PRS-ID to transmit a triggered AP-PRS. For example, bits may be mapped to one or more different PRS resource set IDs.

Format type 4 comprises bit mapping to one or more PRS resources. Using this format type, different blocks of the group common DCI may be configured to be associated with one or more PRS-IDs (e.g., one or more TRPs), and bits may be used to identify one or more specific PRS resources used by the TRP corresponding to the PRS-ID to transmit a triggered AP-PRS. For example, bits may be mapped to one or more different PRS resource IDs.

Finally, format type 5 comprises bit mapping to a specific combination of different PRS aspects. That is, using this format type, each block and bit combination can map to a unique combination of one or more PFLs, PRS-IDs, PRS resource set IDs, and PRS resource IDs. As such, the group common DCI may include a number of unique combinations equal to the amount of blocks times the number of combinations per block. For 64 blocks with two bits (four combinations) each, this would result in 256 different combinations. An example mapping for a given two-bit block could be as follows: bits “00” may map to PFL0, PRS-ID1, PRS resource set ID2, and PRS resource ID5; bits “01” may map to PFL1, PRS-ID6, PRS resource set ID3, and PRS resource ID8; bits “10” may map to PFL3, PRS-ID2, PRS resource set ID3, and PRS resource ID8; and bits “11” may map to PFL2, PRS-ID 10, PRS resource set ID4, and PRS resource ID7. All other blocks of the group common DCI could include a similar set of bit mappings unique to the group common DCI.

According to some embodiments, multiple format types may be supported by a governing specification. Moreover, different UEs may be configured for different format types. Some UEs may be configured for multiple format types. Some UEs may be capable of receiving different format types via different component carriers (CCs). For example, in one CC a UE may receive AP-PRS triggering via group common DCI using format type 1, and in another CC the UE may receive AP-PRS triggering via group common DCI using format type 2.

As noted, group common DCI may be used for positioning measurement report triggering, in addition or as an alternative to the AP-PRS triggering commands described above and in Table 1. According to some embodiments, positioning measurement report triggering can use bits of a block of group common DCI to identify a positioning method and quality of service (QOS) requirement to one or more UEs receiving the group common DCI for positioning measurement reporting.

For example, according to a first option, each block can be associated with a specific positioning method. Positioning methods can include, for example, OTDOA, RTT, or AOD positioning, as described with regard to FIGS. 6-8. Bits can be associated with QOS requirements such as horizontal and/or vertical accuracy, response time, velocity, or the like.

According to a second option, different blocks of the group common DCI may be configured to correspond with different QOS requirements, and bits can indicate a positioning method. According to some embodiments, QOS requirements can be specific to different applications. For example, block 0 of the group common DCI may be associated with high-end QOS having a 1 m accuracy, and block 1 may be associated with low-and QOS having a 50 m accuracy.

FIG. 10 is a diagram illustrating how, according to some embodiments, blocks of a group common DCI may include AP-PRS trigger commands and positioning measurement report commands. In the example illustrated in FIG. 10, a single block, block k (representing, for example, any of blocks 0 to n-1 of FIG. 9), can include two bits for positioning measurement report command mapping (e.g., as described above with regard to position measurement report commands) and two bits for AP-PRS trigger command mapping (e.g., as described above with regard to AP-PRS report command formats types 1-5).

It can be further noted that, because each UE has its own capabilities, reporting provided by different UEs of the UE group receiving the group common DCI may vary in content and report time. For example, a first UE may comprise a mobile phone having a relatively high amount of processing power and bandwidth, and capable of providing a relatively large number of measurements with a relatively short response time, whereas a second UE may comprise an IoT device capable of providing a relatively small number of measurements with a relatively long response time.

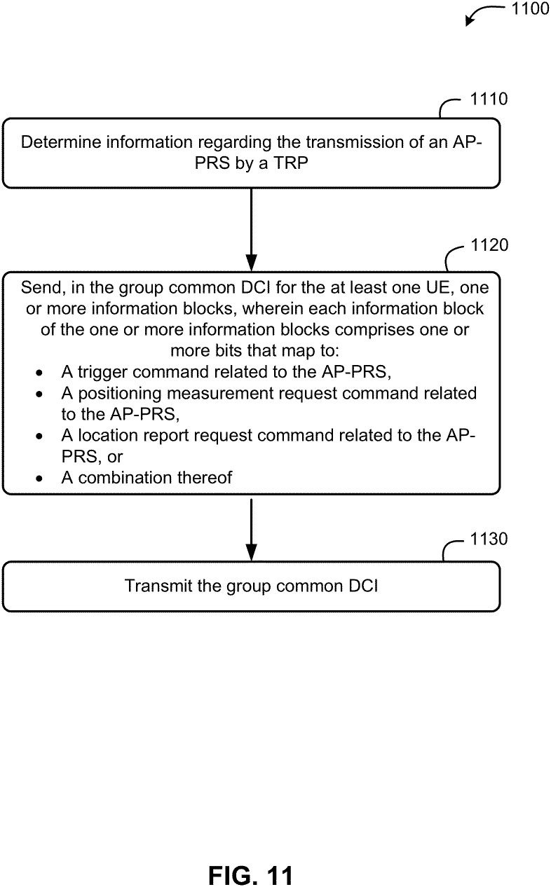

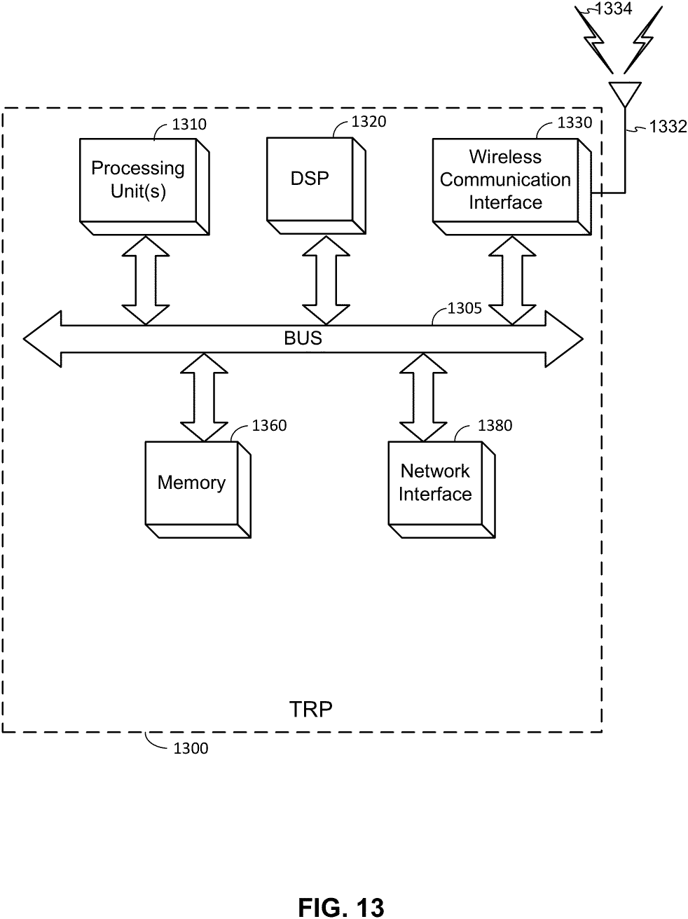

FIG. 11 is a flow diagram of a method 1100 of providing AP-PRS information to at least one UE via group common DCI, according to an embodiment. Means for performing the functionality illustrated in one or more of the blocks shown in FIG. 11 may be performed by hardware and/or software components of a base station or TRP. Example components of a TRP are illustrated in FIG. 13, which are described in more detail below.

At block 1110, the functionality comprises determining information regarding the transmission of an AP-PRS by a TRP. As noted, in some embodiments, this information may be determined by a serving TRP from information received by an LMF. The AP-PRS may be transmitted a TRP performing the method 1100 (e.g., a serving TRP) or another TRP. In some embodiments, the LMF may be co-located with the serving TRP at a gNB. In other embodiments, the information may be obtained from a serving TRP that may orchestrate the AP-PRS from among a plurality of nearby TRPs. Means for performing functionality at block 1110 may comprise a wireless communication interface 1330, bus 1305, DSP 1320, assessing unit(s) 1310, memory 1360, and/or other components of a TRP 1300, as illustrated in FIG. 13.

At block 1120, the functionality comprises including, in the group common DCI for the at least one UE, one or more information blocks. Each information block of the plurality information blocks comprises one or more bits that map to a trigger command related to the AP-PRS, a positioning measurement request command related to the AP-PRS, or the location report request command related to the AP-PRS, or a combination thereof. For example, as indicated in the previously-described embodiments, a trigger command related to the AP-PRS may be relayed using one or more different format types, which may include bit mapping, in which different combinations of bits are mapped or indexed two different information related to a triggered AP-PRS. According to some embodiments, the one or more bits of each information block of the one or more information blocks map to (i) a respective one or more PFLs with which the AP-PRS is to be obtained, (ii) a respective one or more PRS identifiers (PRS-IDs) with which the AP-PRS is to be obtained, (iii) a respective one or more resource sets with which the DL-PRS is to be obtained, (iv) a respective one or more resources with which the AP-PRS is to be obtained, or (v) a unique combination of two or more of a PFL, PRS-ID, resource set, and resource with which the DL-PRS is to be obtained.

Optionally, the group common DCI may include a positioning measurement report request command, as noted in the above-described embodiments. As such, according to some embodiments, the one or more bits of each information block of the one or more information blocks map to a QOS requirement to be used for a positioning measurement report of the AP-PRS from the at least one UE. According to some embodiments, the QOS requirement comprises accuracy, response time, velocity request, or horizontal vs. vertical location request, or a combination thereof. Additionally or alternatively, the one or more bits of each information block of the one or more information blocks map to a positioning method to be used for a positioning measurement report of the AP-PRS from the at least one UE.

Means for performing functionality at block 1120 may comprise a 1305, DSP 1320, assessing unit(s) 1310, memory 1360, and/or other components of a TRP 1300, as illustrated in FIG. 13.

At block 1130, the functionality comprises transmitting the group common DCI. According to some embodiments, the format of the common DCI (including the mapping of bits to various types of information) may be included in a governing standard. Where multiple formats/mappings are available, a selected one or more formats/mappings may be provided to the at least one UE by the TRP (e.g., a serving gNB) or LMF. Alternatively, the TRP or LMF may provide the formats/mappings themselves via MAC-CE or LPP configuration. Thus, according to some embodiments, the method 1100 may comprise providing the at least one UE with an indication of how the one or more bits map to the trigger command, the positioning measurement request command, the location report request command related to the AP-PRS, or a combination thereof. Moreover, according to some embodiments, providing the at least one UE with the indication of how the one or more bits map may comprise providing a first UE with a first mapping of the one or more bits, and providing a second UE with a second mapping of the one or more bits, wherein the second mapping is different than the first mapping. These mappings may be responsive to the capabilities of the at least one UE. As such, according to some embodiments, the method 1100 may further comprise obtaining capability information of the at least one UE and determining how the one or more bits map to the trigger command based at least in part on the capability information. Additionally, according to some embodiments, the method 1100 may further comprise configuring the at least one UE to use two or more information blocks of the group common DCI.

Means for performing functionality at block 1130 may comprise a wireless communication interface 1330, bus 1305, DSP 1320, assessing unit(s) 1310, memory 1360, and/or other components of a TRP 1300, as illustrated in FIG. 13.

According to some embodiments, additional operations may be performed, depending on desired functionality. As noted, different UEs may have different capabilities and may therefore report different information at different times. Accordingly, in some embodiments the at least one UE comprises a plurality of UEs, and the method further includes receiving a first positioning measurement report from a first UE at a first time and a second positioning measurement report from the second UE at a second time. The first time and the second time maybe based on one or more capabilities of the first UE and the second UE respectively. Further, the one or more capabilities of the first UE and the second UE may comprise a number of PRS resources the respective UE can process per time unit, a number of PRS symbols the respective UE can process per time unit, or number of PFLs the respective UE can process per time unit, or a combination thereof.

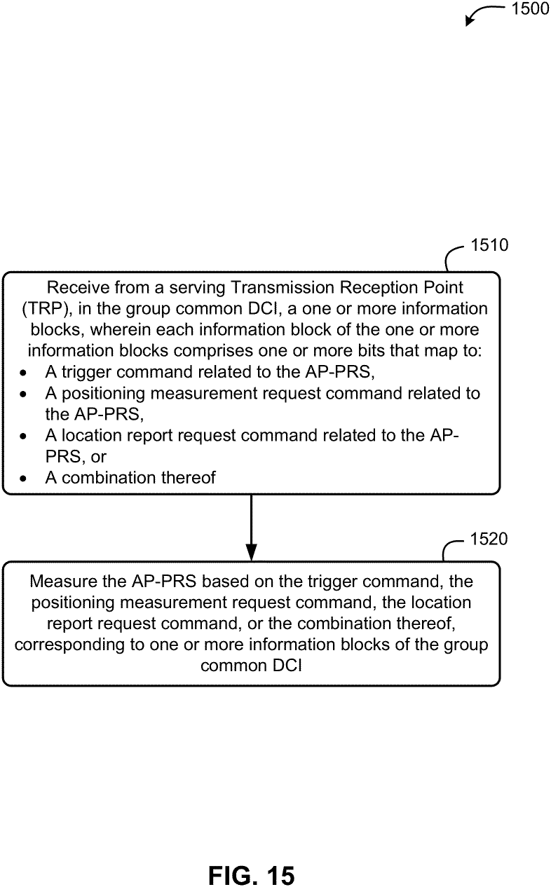

For its part, each UE may be configured to perform a method corresponding to method 1100 for using AP-PRS information in group common DCI. An example of such a method is described hereafter with respect to FIG. 15.

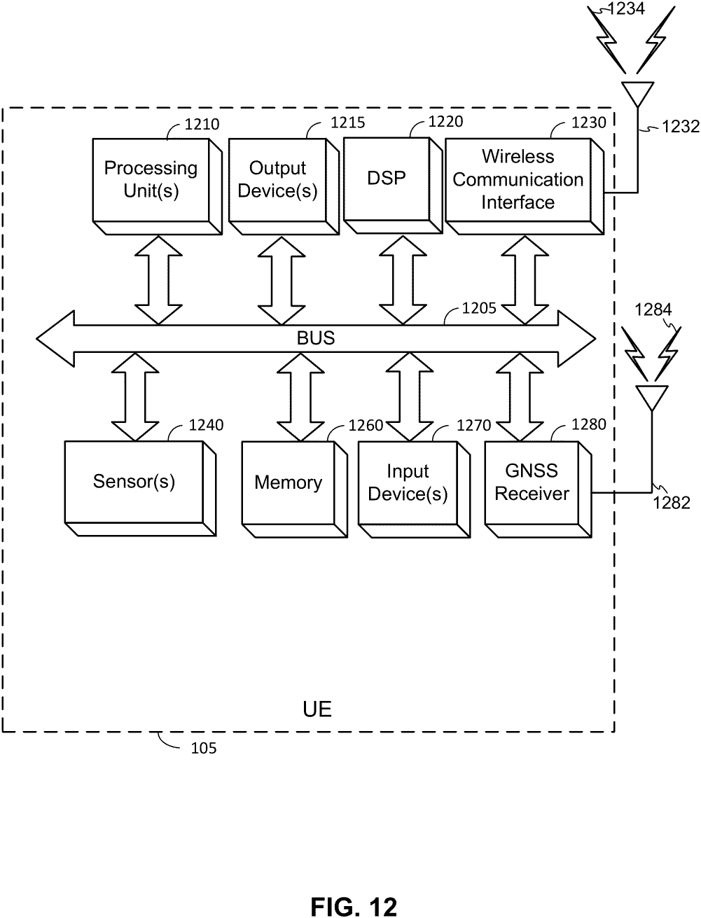

FIG. 12 illustrates an embodiment of a UE 105, which can be utilized as described herein above (e.g., in association with FIGS. 1- 11). It should be noted that FIG. 12 is meant only to provide a generalized illustration of various components, any or all of which may be utilized as appropriate. It can be noted that, in some instances, components illustrated by FIG. 12 can be localized to a single physical device and/or distributed among various networked devices, which may be disposed at different physical locations. Furthermore, as previously noted, the functionality of the UE discussed in the previously described embodiments may be executed by one or more of the hardware and/or software components illustrated in FIG. 12.

The UE 105 is shown comprising hardware elements that can be electrically coupled via a bus 1205 (or may otherwise be in communication, as appropriate). The hardware elements may include a processing unit(s) 1210 which can include without limitation one or more general-purpose processors, one or more special-purpose processors (such as DSP chips, graphics acceleration processors, application specific integrated circuits (ASICs), and/or the like), and/or other processing structures or means. As shown in FIG. 12, some embodiments may have a separate DSP 1220, depending on desired functionality. Location determination and/or other determinations based on wireless communication may be provided in the processing unit(s) 1210 and/or wireless communication interface 1230 (discussed below). The UE 105 also can include one or more input devices 1270, which can include without limitation one or more keyboards, touch screens, touch pads, microphones, buttons, dials, switches, and/or the like; and one or more output devices 1215, which can include without limitation one or more displays (e.g., touch screens), light emitting diodes (LEDs), speakers, and/or the like.

The UE 105 may also include a wireless communication interface 1230, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, a WAN device, and/or various cellular devices, etc.), and/or the like, which may enable the UE 105 to communicate with other devices as described in the embodiments above. As such, the wireless communication interface 1230 can include RF circuitry capable of being receiving obtaining group common DCI and AP-PRS from one or more TRPs as described herein. The wireless communication interface 1230 may permit data and signaling to be communicated (e.g., transmitted and received) with TRPs of a network, for example, via eNBs, gNBs, ng-eNBs, access points, various base stations and/or other access node types, and/or other network components, computer systems, and/or any other electronic devices communicatively coupled with TRPs, as described herein. The communication can be carried out via one or more wireless communication antenna(s) 1232 that send and/or receive wireless signals 1234. According to some embodiments, the wireless communication antenna(s) 1232 may comprise a plurality of discrete antennas, antenna arrays, or a combination thereof.

Depending on desired functionality, the wireless communication interface 1230 may comprise a separate receiver and transmitter, or a combination of transceivers, transmitters, and/or receivers to communicate with base stations (e.g., ng-eNBs and gNBs) and other terrestrial transceivers, such as wireless devices and access points. The UE 105 may communicate with different data networks that may comprise various network types. For example, a Wireless Wide Area Network (WWAN) may be a CDMA network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMAX (IEEE 802.16) network, and so on. A CDMA network may implement one or more RATs such as CDMA2000, WCDMA, and so on. CDMA2000 includes IS-95, IS-2000 and/or IS-856 standards. A TDMA network may implement GSM, Digital Advanced Mobile Phone System (D-AMPS), or some other RAT. An OFDMA network may employ LTE, LTE Advanced, 5G NR, and so on. 5G NR, LTE, LTE Advanced, GSM, and WCDMA are described in documents from 3GPP. Cdma2000 is described in documents from a consortium named “3rd Generation Partnership Project 3” (3GPP2). 3GPP and 3GPP2 documents are publicly available. A WLAN may also be an IEEE 802.11x network, and a wireless personal area network (WPAN) may be a Bluetooth network, an IEEE 802.15x, or some other type of network. The techniques described herein may also be used for a combination of WWAN, WLAN and/or WPAN.

The UE 105 can further include sensor(s) 1240. Sensors 1240 may comprise, without limitation, one or more inertial sensors and/or other sensors (e.g., accelerometer(s), gyroscope(s), camera(s), magnetometer(s), altimeter(s), microphone(s), proximity sensor(s), light sensor(s), barometer(s), and the like), some of which may be used to obtain position-related measurements and/or other information.

Embodiments of the UE 105 may also include a Global Navigation Satellite System (GNSS) receiver 1280 capable of receiving signals 1284 from one or more GNSS satellites using an antenna 1282 (which could be the same as antenna 1232). Positioning based on GNSS signal measurement can be utilized to complement and/or incorporate the techniques described herein. The GNSS receiver 1280 can extract a position of the UE 105, using conventional techniques, from GNSS satellites 110 of a GNSS system, such as Global Positioning System (GPS), Galileo, GLONASS, Quasi-Zenith Satellite System (QZSS) over Japan, Indian Regional Navigational Satellite System (IRNSS) over India, BeiDou Navigation Satellite System (BDS) over China, and/or the like. Moreover, the GNSS receiver 1280 can be used with various augmentation systems (e.g., a Satellite Based Augmentation System (SBAS)) that may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

It can be noted that, although GNSS receiver 1280 is illustrated in FIG. 12 as a distinct component, embodiments are not so limited. As used herein, the term “GNSS receiver” may comprise hardware and/or software components configured to obtain GNSS measurements (measurements from GNSS satellites). In some embodiments, therefore, the GNSS receiver may comprise a measurement engine executed (as software) by one or more processing units, such as processing unit(s) 1210, DSP 1220, and/or a processing unit within the wireless communication interface 1230 (e.g., in a modem). A GNSS receiver may optionally also include a positioning engine, which can use GNSS measurements from the measurement engine to determine a position of the GNSS receiver using an Extended Kalman Filter (EKF), Weighted Least Squares (WLS), a hatch filter, particle filter, or the like. The positioning engine may also be executed by one or more processing units, such as processing unit(s) 1210 or DSP 1220.

The UE 105 may further include and/or be in communication with a memory 1260. The memory 1260 can include, without limitation, local and/or network accessible storage, a disk drive, a drive array, an optical storage device, a solid-state storage device, such as a random access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 1260 of the UE 105 also can comprise software elements (not shown in FIG. 12), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 1260 that are executable by the UE 105 (and/or processing unit(s) 1210 or DSP 1220 within UE 105). In an aspect, then such code and/or instructions can be used to configure and/or adapt a general-purpose computer (or other device) to perform one or more operations in accordance with the described methods.

FIG. 13 illustrates an embodiment of a TRP 1300, which can be utilized as described herein above (e.g., in association with FIGS. 1-12). For example, the TRP 1300 can perform one or more of the functions of the method shown in FIG. 11. It should be noted that FIG. 13 is meant only to provide a generalized illustration of various components, any or all of which may be utilized as appropriate.

The TRP 1300 is shown comprising hardware elements that can be electrically coupled via a bus 1305 (or may otherwise be in communication, as appropriate). The hardware elements may include a processing unit(s) 1310 which can include without limitation one or more general-purpose processors, one or more special-purpose processors (such as DSP chips, graphics acceleration processors, ASICs, and/or the like), and/or other processing structure or means. As shown in FIG. 13, some embodiments may have a separate DSP 1320, depending on desired functionality. Location determination and/or other determinations based on wireless communication may be provided in the processing unit(s) 1310 and/or wireless communication interface 1330 (discussed below), according to some embodiments. The TRP 1300 also can include one or more input devices, which can include without limitation a keyboard, display, mouse, microphone, button(s), dial(s), switch(es), and/or the like; and one or more output devices, which can include without limitation a display, light emitting diode (LED), speakers, and/or the like.

The TRP 1300 might also include a wireless communication interface 1330, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, cellular communication facilities, etc.), and/or the like, which may enable the TRP 1300 to communicate as described herein. The wireless communication interface 1330 may permit data and signaling to be communicated (e.g., transmitted and received) to UEs, other base stations/TRPs (e.g., eNBs, gNBs, and ng-eNBs), and/or other network components, computer systems, and/or any other electronic devices described herein. The communication can be carried out via one or more wireless communication antenna(s) 1332 that send and/or receive wireless signals 1334.

The TRP 1300 may also include a network interface 1380, which can include support of wireline communication technologies. The network interface 1380 may include a modem, network card, chipset, and/or the like. The network interface 1380 may include one or more input and/or output communication interfaces to permit data to be exchanged with a network, communication network servers, computer systems, and/or any other electronic devices described herein.

In many embodiments, the TRP 1300 may further comprise a memory 1360. The memory 1360 can include, without limitation, local and/or network accessible storage, a disk drive, a drive array, an optical storage device, a solid-state storage device, such as a RAM, and/or a ROM, which can be programmable, flash-updateable, and/or the like. Such storage devices may be configured to implement any appropriate data stores, including without limitation, various file systems, database structures, and/or the like.

The memory 1360 of the TRP 1300 also may comprise software elements (not shown in FIG. 13), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 1360 that are executable by the TRP 1300 (and/or processing unit(s) 1310 or DSP 1320 within TRP 1300). In an aspect, then such code and/or instructions can be used to configure and/or adapt a general-purpose computer (or other device) to perform one or more operations in accordance with the described methods.

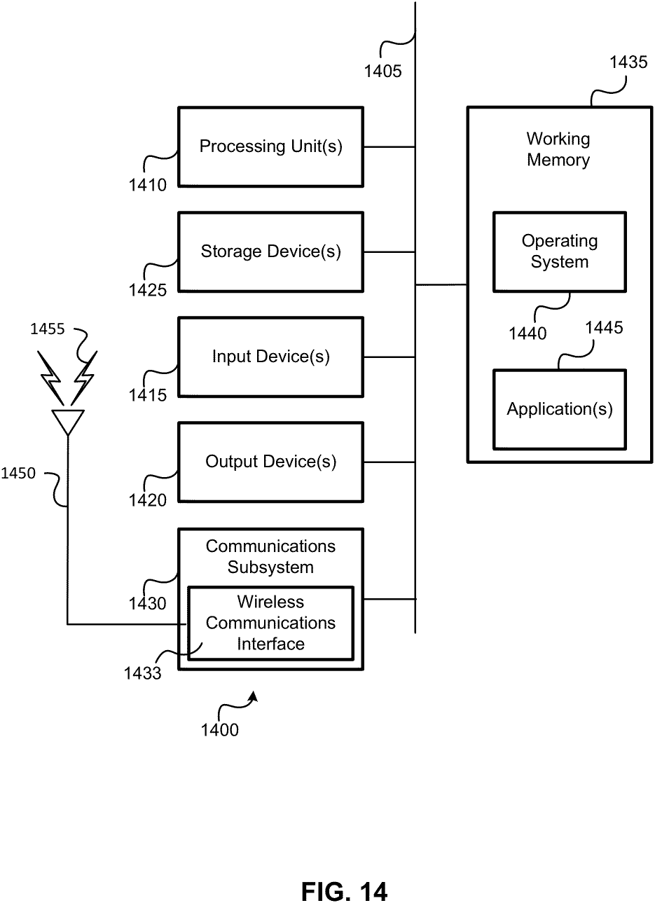

FIG. 14 is a block diagram of an embodiment of a computer system 1400, which may be used, in whole or in part, to provide the functions of one or more network components as described in the embodiments herein (e.g., location server 160 of FIG. 1, LMF 220 of FIG. 2, etc.). It should be noted that FIG. 14 is meant only to provide a generalized illustration of various components, any or all of which may be utilized as appropriate. FIG. 14, therefore, broadly illustrates how individual system elements may be implemented in a relatively separated or relatively more integrated manner. In addition, it can be noted that components illustrated by FIG. 14 can be localized to a single device and/or distributed among various networked devices, which may be disposed at different geographical locations.

The computer system 1400 is shown comprising hardware elements that can be electrically coupled via a bus 1405 (or may otherwise be in communication, as appropriate). The hardware elements may include processing unit(s) 1410, which may comprise without limitation one or more general-purpose processors, one or more special-purpose processors (such as digital signal processing chips, graphics acceleration processors, and/or the like), and/or other processing structure, which can be configured to perform one or more of the methods described herein. The computer system 1400 also may comprise one or more input devices 1415, which may comprise without limitation a mouse, a keyboard, a camera, a microphone, and/or the like; and one or more output devices 1420, which may comprise without limitation a display device, a printer, and/or the like.

The computer system 1400 may further include (and/or be in communication with) one or more non-transitory storage devices 1425, which can comprise, without limitation, local and/or network accessible storage, and/or may comprise, without limitation, a disk drive, a drive array, an optical storage device, a solid-state storage device, such as a RAM and/or ROM, which can be programmable, flash-updateable, and/or the like. Such storage devices may be configured to implement any appropriate data stores, including without limitation, various file systems, database structures, and/or the like. Such data stores may include database(s) and/or other data structures used store and administer messages and/or other information to be sent to one or more devices via hubs, as described herein.

The computer system 1400 may also include a communications subsystem 1430, which may comprise wireless communication technologies managed and controlled by a wireless communication interface 1433, as well as wired technologies (such as Ethernet, coaxial communications, universal serial bus (USB), and the like). The wireless communication interface 1433 may send and receive wireless signals 1455 (e.g., signals according to 5G NR or LTE) via wireless antenna(s) 1450. Thus the communications subsystem 1430 may comprise a modem, a network card (wireless or wired), an infrared communication device, a wireless communication device, and/or a chipset, and/or the like, which may enable the computer system 1400 to communicate on any or all of the communication networks described herein to any device on the respective network, including a User Equipment (UE), base stations and/or other TRPs, and/or any other electronic devices described herein. Hence, the communications subsystem 1430 may be used to receive and send data as described in the embodiments herein.

In many embodiments, the computer system 1400 will further comprise a working memory 1435, which may comprise a RAM or ROM device, as described above. Software elements, shown as being located within the working memory 1435, may comprise an operating system 1440, device drivers, executable libraries, and/or other code, such as one or more applications 1445, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processing unit within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the storage device(s) 1425 described above. In some cases, the storage medium might be incorporated within a computer system, such as computer system 1400. In other embodiments, the storage medium might be separate from a computer system (e.g., a removable medium, such as an optical disc), and/or provided in an installation package, such that the storage medium can be used to program, configure, and/or adapt a general purpose computer with the instructions/code stored thereon. These instructions might take the form of executable code, which is executable by the computer system 1400 and/or might take the form of source and/or installable code, which, upon compilation and/or installation on the computer system 1400 (e.g., using any of a variety of generally available compilers, installation programs, compression/decompression utilities, etc.), then takes the form of executable code.

FIG. 15 is a flow diagram of a method 1500 of using AP-PRS information in group common DCI, according to an embodiment. Means for performing the functionality illustrated in one or more of the blocks shown in FIG. 11 may be performed by hardware and/or software components of a UE. Example components of a TRP are illustrated in FIG. 12, which are described in more detail below.

At block 1510, the functionality comprises receiving from a serving Transmission Reception Point (TRP), in the group common DCI, a one or more information blocks, wherein each information block of the one or more information blocks comprises one or more bits that map to a trigger command related to the AP-PRS, a positioning measurement request command related to the AP-PRS, a location report request command related to the AP-PRS, or a combination thereof. For example, as indicated in the previously-described embodiments, a trigger command related to the AP-PRS may be relayed using one or more different format types, which may include bit mapping, in which different combinations of bits are mapped or indexed two different information related to a triggered AP-PRS. According to some embodiments, the one or more bits of each information block of the one or more information blocks map to (i) a respective one or more PFLs with which the AP-PRS is to be obtained, (ii) a respective one or more PRS identifiers (PRS-IDs) with which the AP-PRS is to be obtained, (iii) a respective one or more resource sets with which the DL-PRS is to be obtained, (iv) a respective one or more resources with which the AP-PRS is to be obtained, or (v) a unique combination of two or more of a PFL, PRS-ID, resource set, and resource with which the DL-PRS is to be obtained, or a combination thereof.

Optionally, the group common DCI may include a positioning measurement report request command, as noted in the above-described embodiments. As such, according to some embodiments, the one or more bits of each information block of the one or more information blocks map to a QOS requirement to be used for a positioning measurement report of the AP-PRS from the at least one UE. According to some embodiments, the QOS requirement comprises accuracy, response time, velocity request, or horizontal vs. vertical location request, or a combination thereof. Additionally or alternatively, the one or more bits of each information block of the one or more information blocks map to a positioning method to be used for a positioning measurement report of the AP-PRS from the at least one UE.

Means for performing functionality at block 1510 may comprise a 1205, DSP 1220, processing unit(s) 1210, memory 1260, and/or other components of a UE 105, as illustrated in FIG. 12.

At block 1520, the functionality comprises measuring the AP-PRS based on the trigger command, the positioning measurement request command, the location report request command, or the combination thereof, corresponding to one or more information blocks of the group common DCI. According to some embodiments, the format of the common DCI (including the mapping of bits to various types of information) may be included in a governing standard. Where multiple formats/mappings are available, a selected one or more formats/mappings may be provided to the UE by the TRP (e.g., a serving gNB) or LMF. Alternatively, the TRP or LMF may provide the formats/mappings themselves via MAC-CE or LPP configuration. Thus, according to some embodiments, the method 1500 may comprise receiving an indication of how the one or more bits map to the trigger command, the positioning measurement request command, the location report request command related to the AP-PRS, or a combination thereof. Additionally, according to some embodiments, UE may be configured to use two or more information blocks of the group common DCI.

Means for performing functionality at block 1520 may comprise a wireless communication interface 1230, bus 1205, DSP 1220, assessing unit(s) 1210, memory 1260, and/or other components of a UE 105, as illustrated in FIG. 12.

It will be apparent to those skilled in the art that substantial variations may be made in accordance with specific requirements. For example, customized hardware might also be used and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processing units and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media, volatile media, and transmission media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, a carrier wave as described hereinafter, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the spirit of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description, embodiments may include different combinations of features. Implementation examples are described in the following numbered clauses:

Clause 1. A method of providing aperiodic Position Reference Signal (AP-PRS) information to at least one User Equipment (UE) via group common Downlink Control Information (DCI) for the at least one UE, the method comprising: determining information regarding transmission of an AP-PRS by a Transmission and Reception Point (TRP); sending, in the group common DCI for the at least one UE, one or more information blocks, wherein each information block of the one or more information blocks comprises one or more bits that map to: a trigger command related to the AP-PRS, a positioning measurement request command related to the AP-PRS, or a location report request command related to the AP-PRS, or a combination thereof; and transmitting the group common DCI.

Clause 2. The method of clause 1, wherein the one or more bits of each information block of the one or more information blocks map to: a respective one or more Positioning Frequency Layers (PFLs) with which the AP-PRS is to be obtained; a respective one or more PRS identifiers (PRS-IDs) with which the AP-PRS is to be obtained; a respective one or more resource sets with which the AP-PRS is to be obtained; a respective one or more resources with which the AP-PRS is to be obtained; or a unique combination of two or more of a PFL, PRS-ID, resource set, and resource with which the AP-PRS is to be obtained; or a combination thereof.

Clause 3. The method of any of clauses 1-2 further comprising providing the at least one UE with an indication of how the one or more bits map to: the trigger command, the positioning measurement request command, or the location report request command related to the AP-PRS, or a combination thereof.

Clause 4. The method of clause 3 wherein providing the at least one UE with the indication of how the one or more bits map comprises providing a first UE with a first mapping of the one or more bits, and providing a second UE with a second mapping of the one or more bits, wherein the second mapping is different than the first mapping.

Clause 5. The method of clause 3 further comprising obtaining capability information of the at least one UE; and determining how the one or more bits map to the trigger command based at least in part on the capability information.

Clause 6. The method of any of clauses 1-5 further comprising obtaining capability information of the at least one UE, wherein sending the one or more information blocks in the group common DCI for the at least one UE is responsive to a determination, based on the capability information, that the at least one UE is capable of receiving the AP-PRS information via the group common DCI.

Clause 7. The method of any of clauses 1-6 further comprising configuring the at least one UE to use two or more information blocks of the group common DCI.

Clause 8. The method of any of clauses 1-7 wherein the one or more bits of each information block of the one or more information blocks map to a Quality Of Service (QOS) requirement to be used for a positioning measurement report of the AP-PRS from the at least one UE.

Clause 9. The method of clause 8 wherein the QOS requirement comprises: accuracy, response time, velocity request, or horizontal vs. vertical location request, or a combination thereof.

Clause 10. The method of any of clauses 1-9 wherein the one or more bits of each information block of the one or more information blocks map to a positioning method to be used for a positioning measurement report of the AP-PRS from the at least one UE.

Clause 11. The method of any of clauses 1-10 wherein the at least one UE comprises a plurality of UEs, and the method further includes receiving a first positioning measurement report from a first UE at a first time, and a second positioning measurement report from a second UE at a second time.

Clause 12. The method of clause 11 wherein the first time and the second time are based on one or more capabilities of the first UE and one or more capabilities of the second UE, respectively.

Clause 13. The method of clause 12 wherein the one or more capabilities of the first UE and the one or more capabilities of the second UE comprise: a number of PRS resources the first UE, the second UE, or both, can process per time unit, a number of PRS symbols the first UE, the second UE, or both, can process per time unit, or number of PFLs the first UE, the second UE, or both, can process per time unit, or a combination thereof.

Clause 14. A method at a User Equipment (UE) of using aperiodic Position Reference Signal (AP-PRS) information in group common Downlink Control Information (DCI), the method comprising: receiving from a serving Transmission Reception Point (TRP), in the group common DCI, a one or more information blocks, wherein each information block of the one or more information blocks comprises one or more bits that map to: a trigger command related to an AP-PRS, wherein the AP-PRS is transmitted from the serving TRP or a neighboring TRP, a positioning measurement request command related to the AP-PRS, a location report request command related to the AP-PRS, or a combination thereof; and measuring the AP-PRS based on the trigger command, the positioning measurement request command, the location report request command, or the combination thereof, corresponding to the one or more information blocks of the group common DCI.

Clause 15. The method of clause 14, wherein the one or more bits of each information block of the one or more information blocks map to: a respective one or more Positioning Frequency Layers (PFLs) with which the AP-PRS is measured; a respective one or more PRS identifiers (PRS-IDs) with which the AP-PRS is measured; a respective one or more resource sets with which the AP-PRS is measured; a respective one or more resources with which the AP-PRS is measured; or a unique combination of two or more of a PFL, PRS-ID, resource set, and resource with which the AP-PRS is measured; or a combination thereof.

Clause 16. The method of any of clauses 14-15 further comprising providing capability information to the serving TRP.

Clause 17. The method of any of clauses 14-16 further comprising providing a positioning measurement report of the AP-PRS based on a mapping of the one or more bits of each information block of the one or more information blocks to a positioning method.

Clause 18. A serving Transmission and Reception Point (TRP) for providing aperiodic Position Reference Signal (AP-PRS) information to at least one User Equipment (UE) via group common Downlink Control Information (DCI) for the at least one UE, the serving TRP comprising: a transceiver; a memory; and one or more processors communicatively coupled with the transceiver and the memory, wherein the one or more processors are configured to: determine information regarding transmission of an AP-PRS by the serving TRP or a separate TRP; send, in the group common DCI for the at least one UE, one or more information blocks, wherein each information block of the one or more information blocks comprises one or more bits that map to: a trigger command related to the AP-PRS, a positioning measurement request command related to the AP-PRS, or a location report request command related to the AP-PRS, or a combination thereof; and transmit the group common DCI via the transceiver.

Clause 19. The serving TRP of clause 18, wherein, to send the one or more information blocks in the group common DCI for the at least one UE, the one or more processors are configured to map the one or more bits of each information block of the one or more information blocks to: a respective one or more Positioning Frequency Layers (PFLs) with which the AP-PRS is to be obtained; a respective one or more PRS identifiers (PRS-IDs) with which the AP-PRS is to be obtained; a respective one or more resource sets with which the AP-PRS is to be obtained; a respective one or more resources with which the AP-PRS is to be obtained; or a unique combination of two or more of a PFL, PRS-ID, resource set, and resource with which the AP-PRS is to be obtained; or a combination thereof.

Clause 20. The serving TRP of any of clauses 18-19 wherein the one or more processors are further configured to provide the at least one UE with an indication of how the one or more bits map to: the trigger command, the positioning measurement request command, or the location report request command related to the AP-PRS, or a combination thereof.

Clause 21. The serving TRP of clause 20 wherein, to provide the at least one UE with the indication of how the one or more bits map, the one or more processors are configured to provide a first UE with a first mapping of the one or more bits, and provide a second UE with a second mapping of the one or more bits, wherein the second mapping is different than the first mapping.

Clause 22. The serving TRP of clause 20 wherein the one or more processors are further configured to: obtain capability information of the at least one UE; and determine how the one or more bits map to the trigger command based at least in part on the capability information.

Clause 23. The serving TRP of any of clauses 18-22 wherein the one or more processors are further configured to obtain capability information of the at least one UE, wherein the one or more processors are configured to send the one or more information blocks in the group common DCI for the at least one UE responsive to a determination, based on the capability information, that the at least one UE is capable of receiving the AP-PRS information via the group common DCI.

Clause 24. The serving TRP of any of clauses 18-23 wherein the one or more processors are further configured to configure the at least one UE to use two or more information blocks of the group common DCI.

Clause 25. The serving TRP of any of clauses 18-24 wherein the one or more processors are configured to map the one or more bits of each information block of the one or more information blocks to a Quality Of Service (QOS) requirement to be used for a positioning measurement report of the AP-PRS from the at least one UE.

Clause 26. The serving TRP of clause 25 wherein the QOS requirement comprises: accuracy, response time, velocity request, or horizontal vs. vertical location request, or a combination thereof.

Clause 27. The serving TRP of any of clauses 18-26 wherein the one or more processors are configured to map the one or more bits of each information block of the one or more information blocks to a positioning method to be used for a positioning measurement report of the AP-PRS from the at least one UE.

Clause 28. The serving TRP of any of clauses 18-27 wherein the one or more processors are configured to receive: a first positioning measurement report from a first UE of the at least one UE at a first time, and a second positioning measurement report from a second UE of the at least one UE at a second time.

Clause 29. The serving TRP of clause 28 wherein the one or more processors are configured to base the first time and the second time on one or more capabilities of the first UE and one or more capabilities of the second UE, respectively.

Clause 30. The serving TRP of clause 29 wherein the one or more capabilities of the first UE and the one or more capabilities of the second UE comprise: a number of PRS resources the first UE, the second UE, or both, can process per time unit, a number of PRS symbols the first UE, the second UE, or both, can process per time unit, or number of PFLs the first UE, the second UE, or both, can process per time unit, or a combination thereof.

Clause 31. A user equipment (UE) for using aperiodic Position Reference Signal (AP-PRS) information in group common Downlink Control Information (DCI), the UE comprising: a transceiver; a memory; and one or more processors communicatively coupled with the transceiver and the memory, wherein the one or more processors are configured to: receive from a serving Transmission Reception Point (TRP) via the transceiver, in the group common DCI, a one or more information blocks, wherein each information block of the one or more information blocks comprises one or more bits that map to: a trigger command related to an AP-PRS, wherein the AP-PRS is transmitted from the serving TRP or a neighboring TRP, a positioning measurement request command related to the AP-PRS, a location report request command related to the AP-PRS, or a combination thereof; and measure the AP-PRS based on the trigger command, the positioning measurement request command, or the location report request command, or the combination thereof, corresponding to the one or more information blocks of the group common DCI.

Clause 32. The UE of clause 31, wherein the one or more processors are configured to determine, from a mapping of the one or more bits of each information block of the one or more information blocks: a respective one or more Positioning Frequency Layers (PFLs) with which the AP-PRS is measured; a respective one or more PRS identifiers (PRS-IDs) with which the AP-PRS is measured; a respective one or more resource sets with which the AP-PRS is measured; a respective one or more resources with which the AP-PRS is measured; or a unique combination of two or more of a PFL, PRS-ID, resource set, and resource with which the AP-PRS is measured; or a combination thereof.

Clause 33. The UE of any of clauses 31-32 wherein the one or more processors are further configured to provide capability information to the serving TRP via the transceiver.

Clause 34. The UE of any of clauses 31-33 wherein the one or more processors are further configured to provide a positioning measurement report of the AP-PRS based on a mapping of the one or more bits of each information block of the one or more information blocks to a positioning method.

Clause 35. An apparatus having means for performing the method of any one of clauses 1-17.

Clause 36. A non-transitory computer-readable medium storing instructions comprising code for performing the method of any one of clauses 1-17.

What is claimed is:

1. A method of providing aperiodic Position Reference Signal (AP-PRS) information to at least one User Equipment (UE) via group common Downlink Control Information (DCI) for the at least one UE, the method comprising:
determining information regarding transmission of an AP-PRS by a Transmission and Reception Point (TRP);
sending, in the group common DCI for the at least one UE, one or more information blocks, wherein each information block of the one or more information blocks comprises one or more bits that map to:
a trigger command related to the AP-PRS,
a positioning measurement request command related to the AP-PRS, or
a location report request command related to the AP-PRS, or
a combination thereof; and
transmitting the group common DCI.

2. The method of claim 1, wherein the one or more bits of each information block of the one or more information blocks map to:
a respective one or more Positioning Frequency Layers (PFLs) with which the AP-PRS is to be obtained;
a respective one or more PRS identifiers (PRS-IDs) with which the AP-PRS is to be obtained;
a respective one or more resource sets with which the AP-PRS is to be obtained;
a respective one or more resources with which the AP-PRS is to be obtained; or
a unique combination of two or more of a PFL, PRS-ID, resource set, and resource with which the AP-PRS is to be obtained; or
a combination thereof.

3. The method of claim 1, further comprising providing the at least one UE with an indication of how the one or more bits map to:
the trigger command,
the positioning measurement request command, or
the location report request command related to the AP-PRS, or
a combination thereof.

4. The method of claim 3, wherein providing the at least one UE with the indication of how the one or more bits map comprises providing a first UE with a first mapping of the one or more bits, and providing a second UE with a second mapping of the one or more bits, wherein the second mapping is different than the first mapping.

5. The method of claim 3, further comprising:
obtaining capability information of the at least one UE; and
determining how the one or more bits map to the trigger command based at least in part on the capability information.

6. The method of claim 1, further comprising obtaining capability information of the at least one UE, wherein sending the one or more information blocks in the group common DCI for the at least one UE is responsive to a determination, based on the capability information, that the at least one UE is capable of receiving the AP-PRS information via the group common DCI.

7. The method of claim 1, further comprising configuring the at least one UE to use two or more information blocks of the group common DCI.

8. The method of claim 1, wherein the one or more bits of each information block of the one or more information blocks map to a Quality Of Service (QOS) requirement to be used for a positioning measurement report of the AP-PRS from the at least one UE.

9. The method of claim 8, wherein the QOS requirement comprises:
accuracy,
response time,
velocity request, or
horizontal vs. vertical location request, or
a combination thereof.

10. The method of claim 1, wherein the one or more bits of each information block of the one or more information blocks map to a positioning method to be used for a positioning measurement report of the AP-PRS from the at least one UE.

11. The method of claim 1, wherein the at least one UE comprises a plurality of UEs, and the method further includes receiving a first positioning measurement report from a first UE at a first time, and a second positioning measurement report from a second UE at a second time.

12. The method of claim 11, wherein the first time and the second time are based on one or more capabilities of the first UE and one or more capabilities of the second UE, respectively.

13. The method of claim 12, wherein the one or more capabilities of the first UE and the one or more capabilities of the second UE comprise:
a number of PRS resources the first UE, the second UE, or both, can process per time unit,
a number of PRS symbols the first UE, the second UE, or both, can process per time unit, or
number of PFLs the first UE, the second UE, or both, can process per time unit, or
a combination thereof.

14. A method at a User Equipment (UE) of using aperiodic Position Reference Signal (AP-PRS) information in group common Downlink Control Information (DCI), the method comprising:
receiving from a serving Transmission Reception Point (TRP), in the group common DCI, a one or more information blocks, wherein each information block of the one or more information blocks comprises one or more bits that map to:
a trigger command related to an AP-PRS, wherein the AP-PRS is transmitted from the serving TRP or a neighboring TRP,
a positioning measurement request command related to the AP-PRS,
a location report request command related to the AP-PRS, or
a combination thereof; and
measuring the AP-PRS based on the trigger command, the positioning measurement request command, the location report request command, or the combination thereof, corresponding to the one or more information blocks of the group common DCI.

15. The method of claim 14, wherein the one or more bits of each information block of the one or more information blocks map to:
a respective one or more Positioning Frequency Layers (PFLs) with which the AP-PRS is measured;
a respective one or more PRS identifiers (PRS-IDs) with which the AP-PRS is measured;
a respective one or more resource sets with which the AP-PRS is measured;
a respective one or more resources with which the AP-PRS is measured; or
a unique combination of two or more of a PFL, PRS-ID, resource set, and resource with which the AP-PRS is measured; or
a combination thereof.

16. The method of claim 14, further comprising providing capability information to the serving TRP.

17. The method of claim 14, further comprising providing a positioning measurement report of the AP-PRS based on a mapping of the one or more bits of each information block of the one or more information blocks to a positioning method.

18. A serving Transmission and Reception Point (TRP) for providing aperiodic Position Reference Signal (AP-PRS) information to at least one User Equipment (UE) via group common Downlink Control Information (DCI) for the at least one UE, the serving TRP comprising:
a transceiver;
a memory; and
one or more processors communicatively coupled with the transceiver and the memory, wherein the one or more processors are configured to:
determine information regarding transmission of an AP-PRS by the serving TRP or a separate TRP;
send, in the group common DCI for the at least one UE, one or more information blocks, wherein each information block of the one or more information blocks comprises one or more bits that map to:
a trigger command related to the AP-PRS,
a positioning measurement request command related to the AP-PRS, or
a location report request command related to the AP-PRS, or
a combination thereof; and
transmit the group common DCI via the transceiver.

19. The serving TRP of claim 18, wherein, to send the one or more information blocks in the group common DCI for the at least one UE, the one or more processors are configured to map the one or more bits of each information block of the one or more information blocks to:
a respective one or more Positioning Frequency Layers (PFLs) with which the AP-PRS is to be obtained;
a respective one or more PRS identifiers (PRS-IDs) with which the AP-PRS is to be obtained;
a respective one or more resource sets with which the AP-PRS is to be obtained;
a respective one or more resources with which the AP-PRS is to be obtained; or
a unique combination of two or more of a PFL, PRS-ID, resource set, and resource with which the AP-PRS is to be obtained; or
a combination thereof.

20. The serving TRP of claim 18, wherein the one or more processors are further configured to provide the at least one UE with an indication of how the one or more bits map to:
the trigger command,
the positioning measurement request command, or
the location report request command related to the AP-PRS, or
a combination thereof.

21. The serving TRP of claim 20, wherein, to provide the at least one UE with the indication of how the one or more bits map, the one or more processors are configured to provide a first UE with a first mapping of the one or more bits, and provide a second UE with a second mapping of the one or more bits, wherein the second mapping is different than the first mapping.

22. The serving TRP of claim 20, wherein the one or more processors are further configured to:
obtain capability information of the at least one UE; and
determine how the one or more bits map to the trigger command based at least in part on the capability information.

23. The serving TRP of claim 18, wherein the one or more processors are further configured to obtain capability information of the at least one UE, wherein the one or more processors are configured to send the one or more information blocks in the group common DCI for the at least one UE responsive to a determination, based on the capability information, that the at least one UE is capable of receiving the AP-PRS information via the group common DCI.

24. The serving TRP of claim 18, wherein the one or more processors are further configured to configure the at least one UE to use two or more information blocks of the group common DCI.

25. The serving TRP of claim 18, wherein the one or more processors are configured to map the one or more bits of each information block of the one or more information blocks to a Quality Of Service (QOS) requirement to be used for a positioning measurement report of the AP-PRS from the at least one UE.

26. The serving TRP of claim 25, wherein the QOS requirement comprises:
accuracy,
response time,
velocity request, or
horizontal vs. vertical location request, or
a combination thereof.

27. The serving TRP of claim 18, wherein the one or more processors are configured to map the one or more bits of each information block of the one or more information blocks to a positioning method to be used for a positioning measurement report of the AP-PRS from the at least one UE.

28. The serving TRP of claim 18, wherein the one or more processors are configured to receive:
a first positioning measurement report from a first UE of the at least one UE at a first time, and
a second positioning measurement report from a second UE of the at least one UE at a second time.

29. The serving TRP of claim 28, wherein the one or more processors are configured to base the first time and the second time on one or more capabilities of the first UE and one or more capabilities of the second UE, respectively.

30. The serving TRP of claim 29, wherein the one or more capabilities of the first UE and the one or more capabilities of the second UE comprise:
a number of PRS resources the first UE, the second UE, or both, can process per time unit,
a number of PRS symbols the first UE, the second UE, or both, can process per time unit, or
number of PFLs the first UE, the second UE, or both, can process per time unit, or
a combination thereof.

31. A user equipment (UE) for using aperiodic Position Reference Signal (AP-PRS) information in group common Downlink Control Information (DCI), the UE comprising:
a transceiver;
a memory; and
one or more processors communicatively coupled with the transceiver and the memory, wherein the one or more processors are configured to:
receive from a serving Transmission Reception Point (TRP) via the transceiver, in the group common DCI, a one or more information blocks, wherein each information block of the one or more information blocks comprises one or more bits that map to:
a trigger command related to an AP-PRS, wherein the AP-PRS is transmitted from the serving TRP or a neighboring TRP,
a positioning measurement request command related to the AP-PRS,
a location report request command related to the AP-PRS, or
a combination thereof; and
measure the AP-PRS based on the trigger command, the positioning measurement request command, or the location report request command, or the combination thereof, corresponding to the one or more information blocks of the group common DCI.

32. The UE of claim 31, wherein the one or more processors are configured to determine, from a mapping of the one or more bits of each information block of the one or more information blocks:
a respective one or more Positioning Frequency Layers (PFLs) with which the AP-PRS is measured;
a respective one or more PRS identifiers (PRS-IDs) with which the AP-PRS is measured;
a respective one or more resource sets with which the AP-PRS is measured;
a respective one or more resources with which the AP-PRS is measured; or
a unique combination of two or more of a PFL, PRS-ID, resource set, and resource with which the AP-PRS is measured; or
a combination thereof.

33. The UE of claim 31, wherein the one or more processors are further configured to provide capability information to the serving TRP via the transceiver.

34. The UE of claim 31, wherein the one or more processors are further configured to provide a positioning measurement report of the AP-PRS based on a mapping of the one or more bits of each information block of the one or more information blocks to a positioning method.
